(19) United States
(12) Patent Application Publication
(10) Pub. No.: US 2026/0261078 A1
(43) Pub. Date: Sep. 3, 2026

(54) CONNECTOR STRUCTURE

(71) Applicant: Japan Aviation Electronics Industry, Limited, Tokyo (JP)

(72) Inventor: Osamu HASHIGUCHI, Tokyo (JP)

(73) Assignee: Japan Aviation Electronics Industry, Limited, Tokyo (JP)

(21) Appl. No.: 19/433,219

(22) Filed: Dec. 26, 2025

(30) Foreign Application Priority Data
Feb. 28, 2025 (JP) 2025-032311

(51) Int. Cl. H01R 13/629; H01R 13/02; H01R 13/04; H01R 13/20; H01R 13/50

(52) U.S. Cl. CPC H01R 13/62933; H01R 13/025; H01R 13/04; H01R 13/20; H01R 13/50

(57) ABSTRACT

A connector structure comprises a first connector and a second connector. The first connector comprises a first housing and a first contact which has a first contacting portion with a groove and a pressed surface. The second connector comprises a second housing, a second contact and a pressing member which has a spring portion and at least one protruding portion. When a posture of the pressing member is changed from a first posture to a second posture in a state where a second contacting portion of the second contact is adjacent to the first contacting portion while the protruding portion is located in the groove, the protruding portion is moved out of the groove to ride on the pressed surface, and the protruding portion presses the pressed surface by using a resilient property of the spring portion and thereby presses the first contacting portion against the second contacting portion.

### CROSS REFERENCE TO RELATED APPLICATIONS

This application is based on and claims priority under 35 U.S.C. §119 to Japanese Patent Applications No. JP 2025-032311 filed Feb. 28, 2025, the contents of which are incorporated herein in their entirety by reference.

### BACKGROUND OF THE INVENTION

This invention relates to a connector structure comprising a first connector and a second connector.

JPA 2019-216065 (Patent Document 1) discloses a lever-type connector 900, or a connector structure 900, of this type. As shown in FIGS. 37 and 38, the connector structure 900 of Patent Document 1 comprises a first connector housing 910, or a first connector 910, and a second connector housing 920, or a second connector 920. The first connector 910 and the second connector 920 are mateable with each other along a Z-direction, or along a first direction. The first connector 910 is provided with cam pins 912. The second connector 920 has a lever 922 which is rotatable between a first operation position, which is shown in FIG. 37, and a second operation position shown in FIG. 38. The lever 922 is formed with cam receivers 9222. The cam pins 912 and the cam receivers 9222 constitute a cam mechanism.

In the connector structure 900, a mating operation of the first connector 910 with the second connector 920 is performed as described below. First, the first connector 910 and the second connector 920 approach each other in the first direction so that the cam pins 912 of the first connector 910 are inserted into the cam receivers 9222, respectively, of the second connector 920. After that, the lever 922 of the second connector 920 is rotated from the first operation position to the second operation position. Then, the cam pins 912 are moved in the cam receivers 9222, respectively, and the first connector 910 further approaches the second connector 920 in the first direction, and thereby the first connector 910 and the second connector 920 are mated with each other. Specifically, the connector structure 900 utilizes the lever principle using the lever 922, and the cam mechanism converts the rotational movement of the lever 922 to a liner movement which causes the first connector 910 and the second connector 920 to approach each other in the first direction. This enables the first connector 910 and the second connector 920 of the connector structure 900 to be mated with each other with small operating force in comparison with an assumption where the connector structure 900 have neither the lever 922 nor the cam mechanism.

A connector structure such as the connector structure of Patent Document 1, is required to reduce operating force upon mating of a first connector and a second connector without increasing a size of the connector structure.

### SUMMARY OF THE INVENTION

It is therefore an object of the present invention to provide a connector structure which can reduce operating force upon mating of a first connector and a second connector without increasing a size of the connector structure.

One aspect of the present invention provides a connector structure comprising a first connector and a second connector. The first connector and the second connector are mateable with each other along a first direction. The first connector comprises a first housing and a first contact. The first contact is held by the first housing. The first contact has a first contacting portion. The first contacting portion is located at a predetermined position in a second direction perpendicular to the first direction. The first contacting portion has a groove and a pressed surface. The groove extends along the first direction. The pressed surface is adjacent to the groove in a third direction perpendicular to both the first direction and the second direction. The second connector comprises a second housing, a second contact and a pressing member. Each of the second contact and the pressing member is directly or indirectly held by the second housing. The second contact has a second contacting portion. The second contacting portion is located adjacent to the predetermined position in the second direction. At least in a state where the second contacting portion is adjacent to the first contacting portion in the second direction, a posture of the pressing member is changeable between a first posture and a second posture by rotating the pressing member about a predetermined axis. The pressing member has a spring portion and at least one protruding portion. The spring portion has a resilient property. The spring portion is located apart from the second contacting portion in the second direction. The protruding portion is supported by the spring portion and is movable in the second direction by using the resilient property of the spring portion. The protruding portion protrudes toward the second contacting portion in the second direction. Together with the change of the posture of the pressing member, the protruding portion is movable on a path in a plane defined by the first direction and the third direction, the path being deviated from the predetermined axis in the plane defined by the first direction and the third direction. When the second connector is moved relative to the first connector along the first direction in a state where the pressing member assumes the first posture while a position of the groove matches a position of the protruding portion in a plane defined by the second direction and the third direction, the first contacting portion is inserted between the second contacting portion and the spring portion while the protruding portion is received in the groove, and the second contacting portion becomes adjacent to the first contacting portion. When the posture of the pressing member is changed from the first posture to the second posture in a state where the second contacting portion is adjacent to the first contacting portion while the protruding portion is located in the groove, the protruding portion is moved out of the groove to ride on the pressed surface, and the protruding portion presses the pressed surface by using the resilient property of the spring portion and thereby presses the first contacting portion against the second contacting portion.

The connector structure of the present invention is configured as follows: when the second connector is moved relative to the first connector along the first direction in the state where the pressing member assumes the first posture while the position of the groove matches the position of the protruding portion in the plane defined by the second direction and the third direction, the first contacting portion is inserted between the second contacting portion and the spring portion while the protruding portion is received in the groove, and the second contacting portion becomes adjacent to the first contacting portion; and, when the posture of the pressing member is changed from the first posture to the second posture in the state where the second contacting portion is adjacent to the first contacting portion while the protruding portion is located in the groove, the protruding portion is moved out of the groove to ride on the pressed surface, and the protruding portion presses the pressed surface by using the resilient property of the spring portion and thereby presses the first contacting portion against the second contacting portion. This configuration enables the connector structure of the present invention to have the following advantages: the second contact of the second connector can be inserted into the first connector with zero insertion force, or ZIF, when the second connector approaches the first connector in the state where the pressing member assumes the first posture; and, when the posture of the pressing member is changed from the first posture to the second posture after the insertion of the second contact into the first connector, the protruding portion of the pressing member presses the pressed surface of the first contact and thereby the first contacting portion of the first contact and the second contacting portion of the second contact are connected to each other. In other words, the connector structure of the present invention can reduce operating force upon the mating of the first connector and the second connector without increasing a size of the connector structure.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a connector structure according to a first embodiment of the present invention. In the figure, a first connector and a second connector are in a pre-mated state where the first connector and the second connector are not mated with each other, and a shaft is located at a first rotation position.

FIG. 2 is another perspective view showing the connector structure of FIG. 1. In the figure, the first connector and the second connector are in a ZIF insertion state where a second contact of the second connector is inserted into the first connector with zero insertion force, and the shaft is located at a first rotation position.

FIG. 3 is a side view showing the connector structure of FIG. 2.

FIG. 4 is a cross-sectional view showing the connector structure of FIG. 3, taken along line A-A. In the figure, a part of the connector structure is enlarged and illustrated.

FIG. 5 is a bottom view showing the connector structure of FIG. 2.

FIG. 6 is a cross-sectional view showing the connector structure of FIG. 5, taken along line B-B. In the figure, a part of the connector structure is enlarged and illustrated.

FIG. 7 is another perspective view showing the connector structure of FIG. 2. In the figure, the first connector and the second connector are in a mated state where the first connector and the second connector are mated with each other, and the shaft is located at a second rotation position.

FIG. 8 is a front view showing the connector structure of FIG. 7.

FIG. 9 is a rear view showing the connector structure of FIG. 7.

FIG. 10 is a side view showing the connector structure of FIG. 7.

FIG. 11 is a cross-sectional view showing the connector structure of FIG. 10, taken along line C-C. In the figure, a part of the connector structure is enlarged and illustrated.

FIG. 12 is a cross-sectional view showing the connector structure of FIG. 10, taken along line D-D. In the figure, a part of the connector structure is enlarged and illustrated.

FIG. 13 is a top view showing the connector structure of FIG. 7.

FIG. 14 is a bottom view showing the connector structure of FIG. 7.

FIG. 15 is a cross-sectional view showing the connector structure of FIG. 14, taken along line E-E. In the figure, a part of the connector structure is enlarged and illustrated.

FIG. 16 is an exploded, perspective view showing the first connector which is included in the connector structure of FIG. 1.

FIG. 17 is a side view showing one of first contacts which are included in the first connector of FIG. 16.

FIG. 18 is a top view showing the first contact of FIG. 17.

FIG. 19 is an exploded, perspective view showing the second connector which is included in the connector structure of FIG. 7.

FIG. 20 is a perspective view showing one of pressing members which are included in the second connector of FIG. 19.

FIG. 21 is a front view showing the pressing member of FIG. 20.

FIG. 22 is a top view showing the pressing member of FIG. 20.

FIG. 23 is a bottom view showing the pressing member of FIG. 20.

FIG. 24 is a side view showing the pressing member of FIG. 20.

FIG. 25 is another side view showing the pressing member of FIG. 20.

FIG. 26 is a side view showing one of second contacts which are included in the second connector of FIG. 19.

FIG. 27 is another side view showing the second contact of FIG. 26.

FIG. 28 is a perspective view showing a connector structure according to a second embodiment of the present invention. In the figure, a first connector and a second connector are in a pre-mated state where the first connector and the second connector are not mated with each other. Additionally, in the figure, a part of the first connector is enlarged and illustrated.

FIG. 29 is another perspective view showing the connector structure of FIG. 28. In the figure, the first connector and the second connector are in a ZIF insertion state where a second contact of the second connector is inserted into the first connector with zero insertion force, and a second housing is located at a first rotation position.

FIG. 30 is a side view showing the connector structure of FIG. 29.

FIG. 31 is a cross-sectional view showing the connector structure of FIG. 30, taken along line F-F. In the figure, a part of the connector structure is enlarged and illustrated.

FIG. 32 is another perspective view showing the connector structure of FIG. 29. In the figure, the first connector and the second connector are in a mated state where the first connector and the second connector are mated with each other, and the second housing is located at a second rotation position.

FIG. 33 is a side view showing the connector structure of FIG. 32.

FIG. 34 is a cross-sectional view showing the connector structure of FIG. 33, taken along line G-G. In the figure, a part of the connector structure is enlarged and illustrated.

FIG. 35 is a cross-sectional view showing the connector structure of FIG. 33, taken along line H-H. In the figure, a part of the connector structure is enlarged and illustrated.

FIG. 36 is an exploded, perspective view showing the second connector which is included in the connector structure of FIG. 32. In the figure, a part of the second contact and a part of a pressing member are enlarged and illustrated.

FIG. 37 is a side view showing a lever-type connector described in Patent Document 1. In the figure, a first connector housing and a second connector housing are in an unmated state where the first connector housing and the second connector housing are not mated with each other, a lever is located at a first operation position.

FIG. 38 is a side view showing the lever-type connector of FIG. 37. In the figure, the first connector housing and the second connector housing are in a mated state where the first connector housing and the second connector housing are mated with each other, the lever is located at a second operation position.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### First embodiment

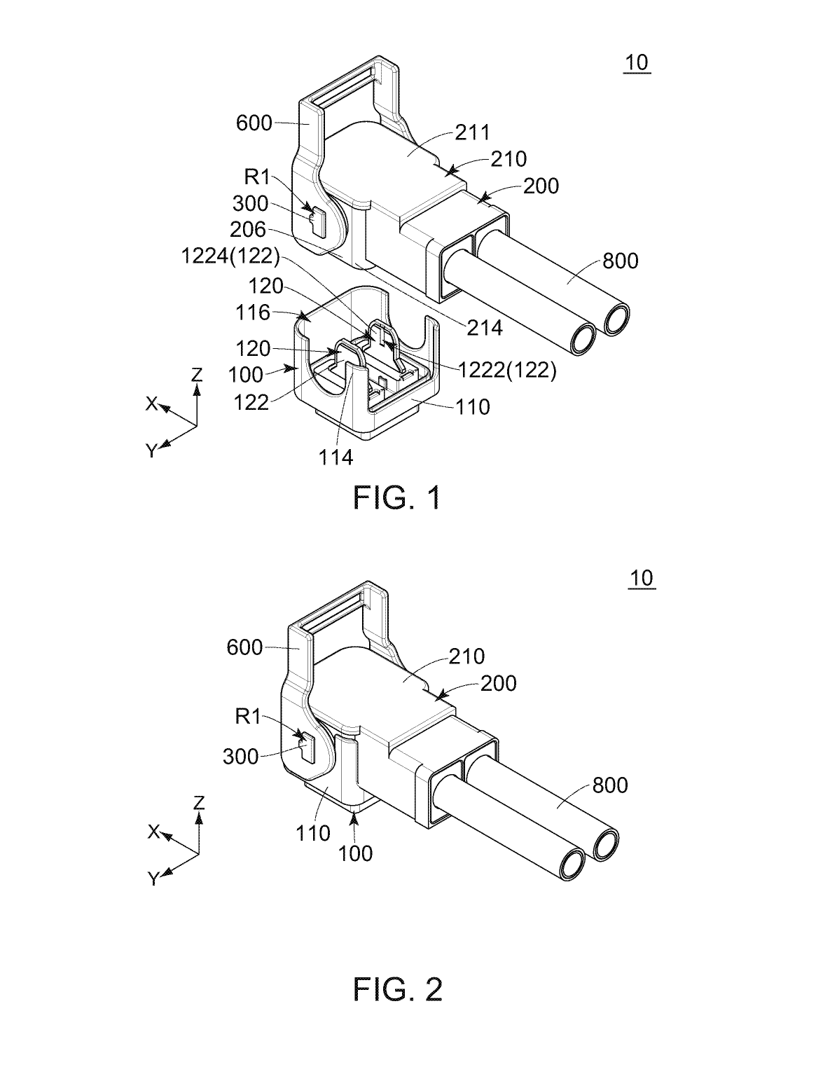

Referring to FIG. 1, a connector structure 10 according to a first embodiment of the present invention comprises a first connector 100 and a second connector 200. Referring to FIGS. 1 and 2, the first connector 100 and the second connector 200 are mateable with each other along a first direction. In the present embodiment, the first direction is a Z-direction. Additionally, the first direction is also referred to as an up-down direction. Specifically, it is assumed that upward is a positive Z-direction while downward is a negative Z-direction. The connector structure 10 of the present embodiment is used for a high-current power supply. However, the present invention is not limited thereto. Specifically, the connector structure 10 may also be used for another application.

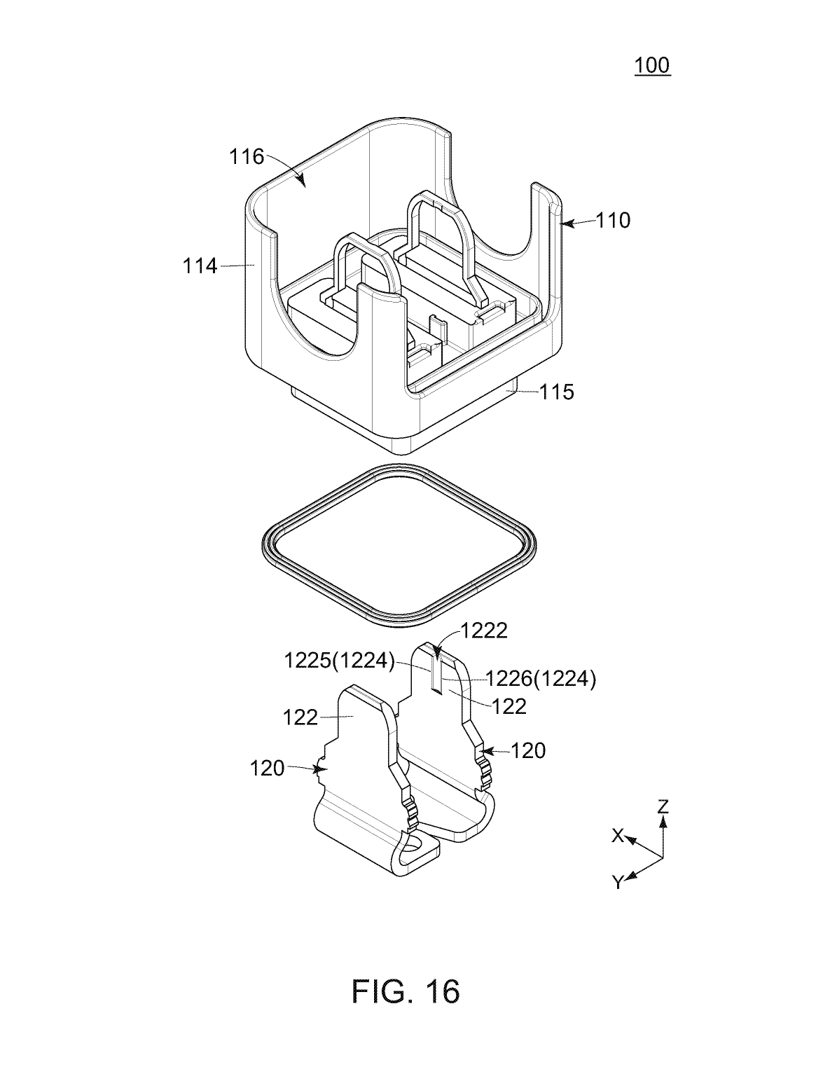

As shown in FIG. 16, the first connector 100 of the present embodiment comprises a first housing 110 and two first contacts 120. However, the present invention is not limited thereto. Specifically, the number of the first contact 120 may be one. In other words, the first connector 100 should comprise the first housing 110 and the single first contact 120.

Referring to FIG. 16, the first housing 110 of the present embodiment is made of insulator. The first housing 110 has a regulating portion 114, a bottom portion 115 and a mating portion accommodating portion 116.

Referring to FIG. 16, the regulating portion 114 of the present embodiment extends in the first direction from the bottom portion 115. Specifically, the regulating portion 114 extends upward in the up-down direction from the bottom portion 115. The regulating portion 114 defines an end of the first housing 110 in the first direction. Specifically, the regulating portion 114 defines an upper end of the first housing 110 in the up-down direction. In the present embodiment, the upper end of the first housing 110 is also an upper end of the first connector 100. The regulating portion 114 defines opposite ends of the first housing 110 in a second direction perpendicular to the first direction. The regulating portion 114 defines opposite ends of the first connector 100 in the second direction. In the present embodiment, the second direction is a Y-direction.

Referring to FIG. 16, the bottom portion 115 of the present embodiment defines the other end of the first housing 110 in the first direction. Specifically, the bottom portion 115 defines a lower end of the first housing 110 in the up-down direction. In the present embodiment, the lower end of the first housing 110 is also a lower end of the first connector 100.

Referring to FIG. 16, the mating portion accommodating portion 116 of the present embodiment opens at its one end in the first direction. Specifically, the mating portion accommodating portion 116 opens at its upper end in the up-down direction. The mating portion accommodating portion 116 is surrounded by the regulating portion 114 in a direction perpendicular to the first direction. The mating portion accommodating portion 116 is located above the bottom portion 115 in the up-down direction.

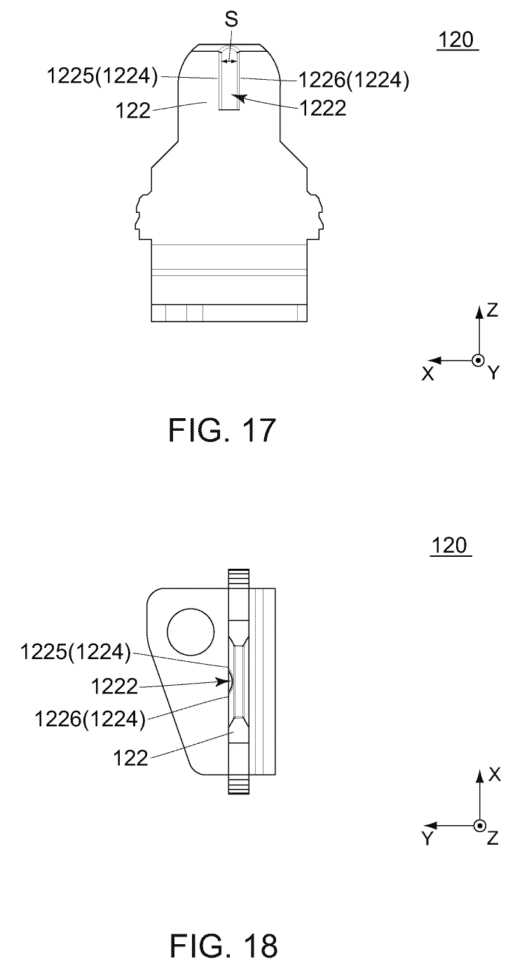

Referring to FIG. 17, each of the first contacts 120 of the present embodiment is made of metal. As shown in FIG. 1, each of the first contacts 120 is held by the first housing 110. More specifically, each of the first contacts 120 is press-fit into the first housing 110. Each of the first contacts 120 is press-fit into the bottom portion 115.

As shown in FIG. 17, each of the first contacts 120 has a first contacting portion 122.

As shown in FIG. 17, the first contacting portion 122 of the present embodiment has a flat-plate shape. The first contacting portion 122 defines an end of the first contact 120 in the first direction. Specifically, the first contacting portion 122 defines an upper end of the first contact 120 in the up-down direction. Referring to FIG. 4, the first contacting portion 122 of the present embodiment is located at a predetermined position PP in the second direction perpendicular to the first direction.

As shown in FIG. 17, the first contacting portion 122 has a groove 1222 and two pressed surfaces 1224. However, the present invention is not limited thereto. Specifically, the number of the pressed surface 1224 may be one. Alternatively, the number of the pressed surfaces 1224 may be three or more. In other words, the first contacting portion 122 should have the groove 1222 and the single pressed surface 1224.

As shown in FIG. 17, the groove 1222 of the present embodiment extends in the first direction. The groove 1222 has a size S in a third direction perpendicular to both the first direction and the second direction. In the present embodiment, the third direction is an X-direction. Additionally, the third direction is also referred to as a front-rear direction. Specifically, it is assumed that forward is a positive X-direction while rearward is a negative X-direction. As shown in FIG. 18, the groove 1222 is recessed in the second direction. The groove 1222 has an arc-shaped cross-section in a plane perpendicular to the first direction. The groove 1222 opens at its one end in the first direction. Specifically, the groove 1222 opens at its upper end in the up-down direction. The groove 1222 opens at its one end in the second direction. Specifically, the groove 1222 opens at its inner end in the second direction. Since the first contact 120 of the present embodiment is configured so that the first contacting portion 122 has the flat-plate shape as described above, it is easy to form the groove 1222.

As shown in FIG. 18, each of the pressed surfaces 1224 of the present embodiment intersects with the second direction. More in detail, each of the pressed surfaces 1224 is a surface perpendicular to the second direction. Each of the pressed surfaces 1224 is adjacent to the groove 1222 in the third direction.

As shown in FIG. 17, the pressed surfaces 1224 include a first pressed surface 1225 and a second pressed surface 1226. The groove 1222 is located between the first pressed surface 1225 and the second pressed surface 1226 in the third direction. The first pressed surface 1225 is located forward of the second pressed surface 1226 in the front-rear direction. The first pressed surface 1225 is located forward of the groove 1222 in the front-rear direction.

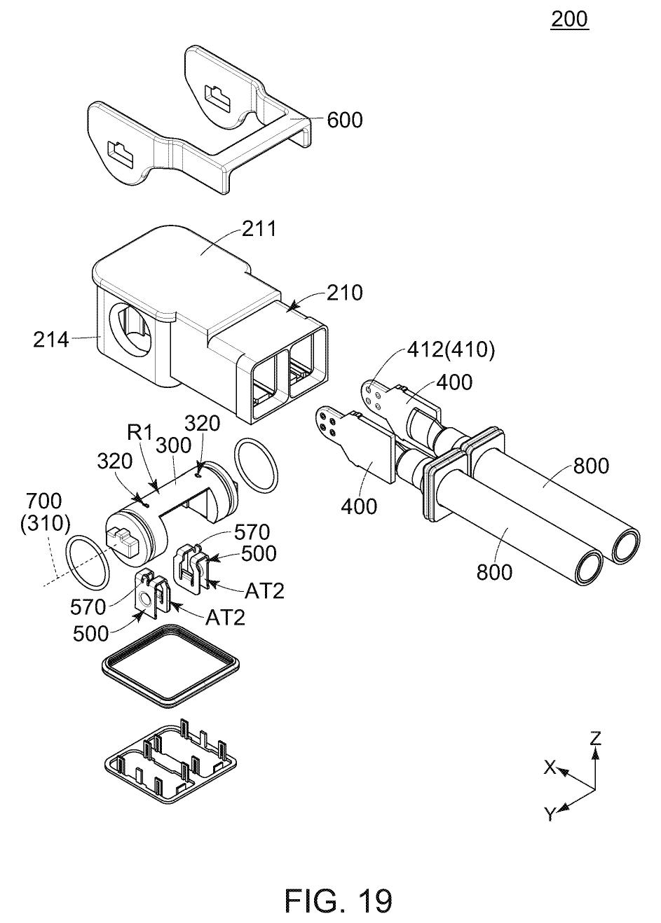

Referring to FIG. 19, the second connector 200 of the present embodiment comprises a second housing 210, two second contacts 400 and two pressing members 500. However, the present invention is not limited thereto. Specifically, the number of each of the second contact 400 and the pressing member 500 may be one. In other words, the second connector 200 should comprise the second housing 210, the single second contact 400 and the single pressing member 500.

Referring to FIG. 19, the second housing 210 of the present embodiment is made of insulator. Referring to FIGS. 1 and 2, when the first connector 100 and the second connector 200 are mated with each other, the first housing 110 regulates a movement of the second housing 210 in a plane defined by the second direction and the third direction. In other words, when the first connector 100 and the second connector 200 are mated with each other, the first housing 110 regulates the movement of the second housing 210 in the plane perpendicular to the first direction.

As shown in FIG. 19, the second housing 210 has a ceiling portion 211 and a regulated portion 214.

Referring to FIG. 19, the ceiling portion 211 of the present embodiment has a plate-like shape perpendicular to the first direction. The ceiling portion 211 defines an end of the second housing 210 in the first direction. Specifically, the ceiling portion 211 defines an upper end of the second housing 210 in the up-down direction. The ceiling portion 211 defines opposite ends of the second housing 210 in the second direction. The ceiling portion 211 defines an end of the second housing 210 in the third direction. Specifically, the ceiling portion 211 defines a front end of the second housing 210 in the front-rear direction.

Referring to FIG. 19, the regulated portion 214 of the present embodiment extends in the first direction from the ceiling portion 211. Specifically, the regulated portion 214 extends downward in the up-down direction from the ceiling portion 211. The regulated portion 214 defines the other end of the second housing 210 in the first direction. Specifically, the regulated portion 214 defines a lower end of the second housing 210 in the up-down direction. In the present embodiment, a lower end of the second housing 210 is also a lower end of the second connector 200. Referring to FIGS. 1 and 2, when the first connector 100 and the second connector 200 are mated with each other, the regulating portion 114 regulates a movement of the regulated portion 214 in the plane defined by the second direction and the third direction. In other words, when the first connector 100 and the second connector 200 are mated with each other, the regulating portion 114 regulates the movement of the regulated portion 214 in the plane perpendicular to the first direction.

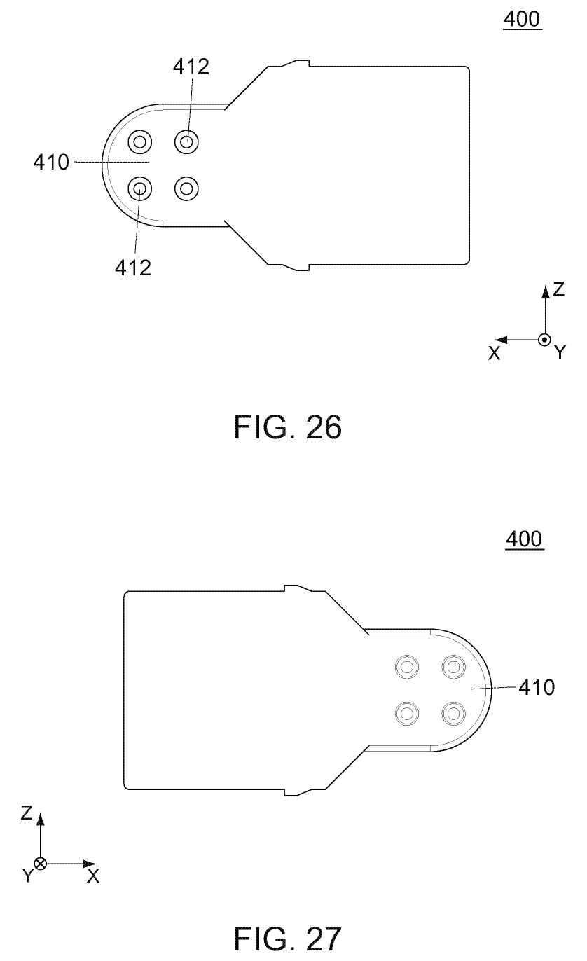

Referring to FIG. 26, each of the second contacts 400 of the present embodiment is made of metal. As shown in FIG. 19, a cable 800 is connected to the second contact 400. Specifically, the cable 800 is connected to a rear end of the second contact 400 in the front-rear direction. As shown in FIG. 4, each of the second contacts 400 is held by the second housing 210. Specifically, each of the second contacts 400 is directly held by the second housing 210. More in detail, each of the second contacts 400 is press-fit into the second housing 210. However, the present invention is not limited thereto. Specifically, the second contact 400 may be indirectly held by the second housing 210. In other words, the second contact 400 should be directly or indirectly held by the second housing 210. The second contacts 400 correspond to the first contacts 120, respectively.

As shown in FIG. 26, each of the second contacts 400 has a second contacting portion 410.

As shown in FIG. 19, the second contacting portion 410 of the present embodiment has a flat-plate shape. As shown in FIG. 26, the second contacting portion 410 has a plurality of protrusions 412. Each of the protrusions 412 protrudes inward in the second direction. As shown in FIG. 4, the second contacting portion 410 is located adjacent to the predetermined position PP in the second direction.

Although each of the first contacting portion 122 and the second contacting portion 410 has the flat-plate shape as described above, the present invention is not limited thereto. Specifically, the first contacting portion 122 may not have the flat-plate shape, and the second contacting portion 410 may not have the flat-plate shape. If the connector structure 10 is used in high-current applications, it is desirable for each of the first contacting portion 122 and the second contacting portion 410 to have the flat-plate shape in order to increase a cross-sectional area of its current path.

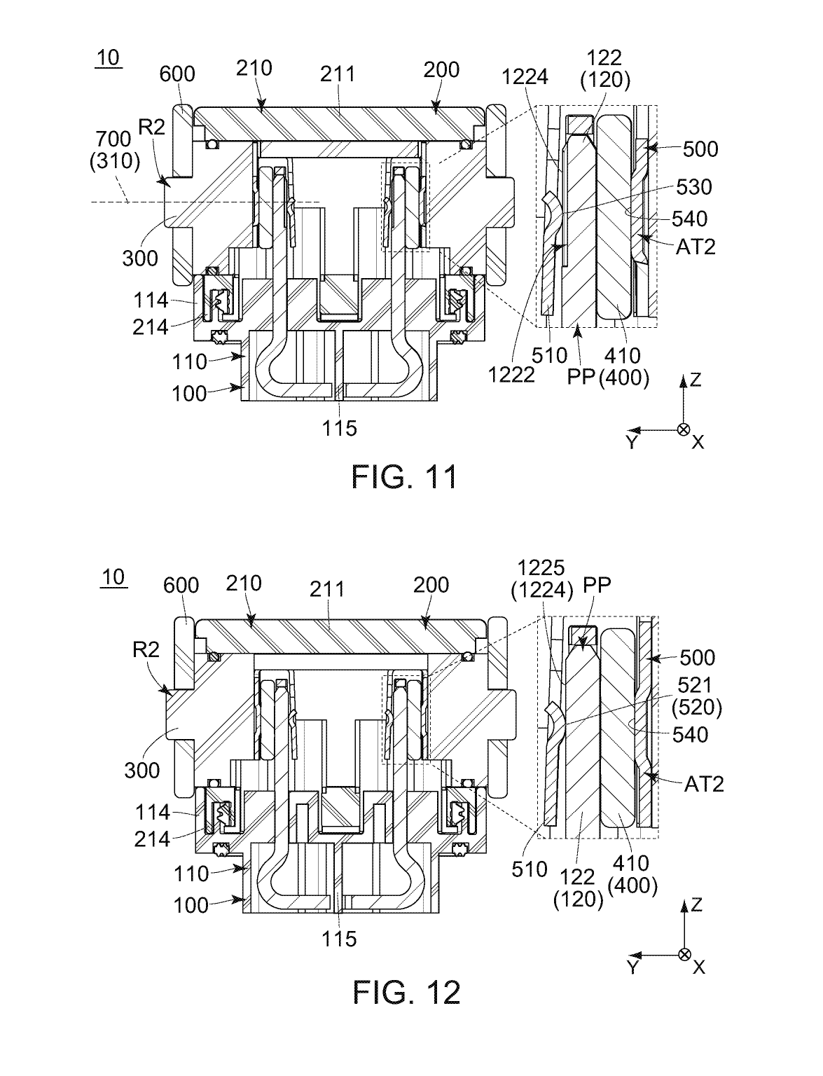

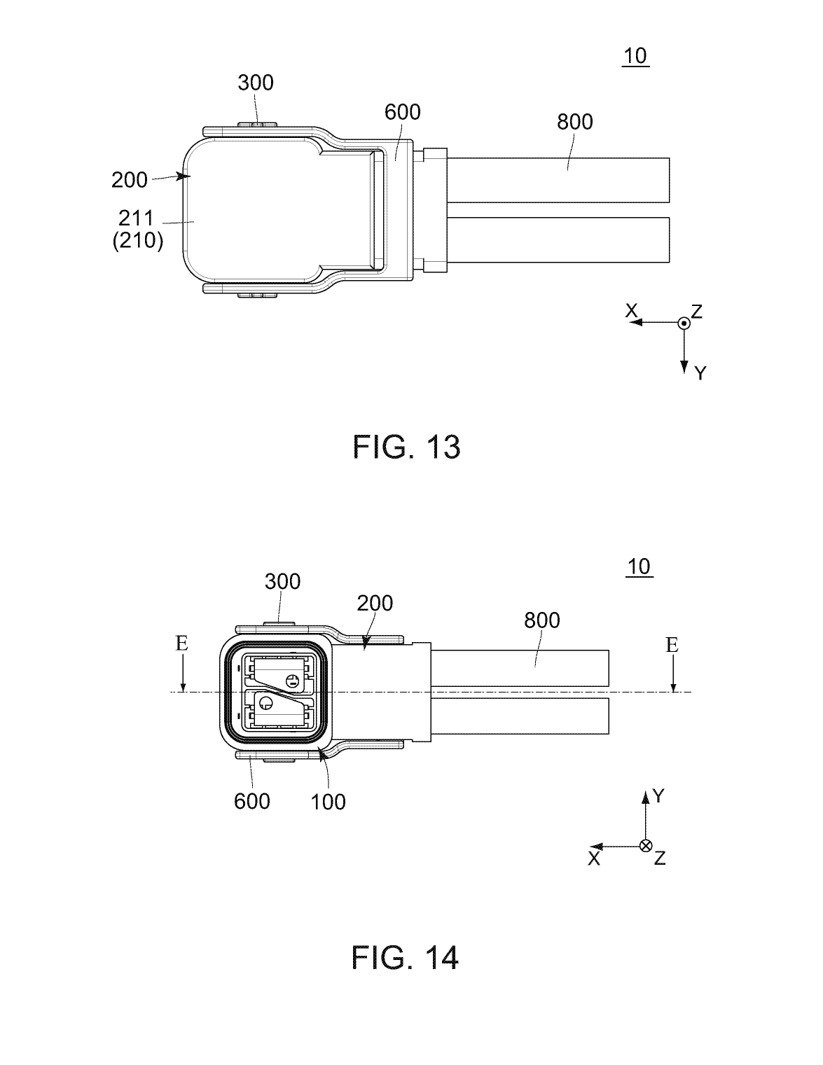

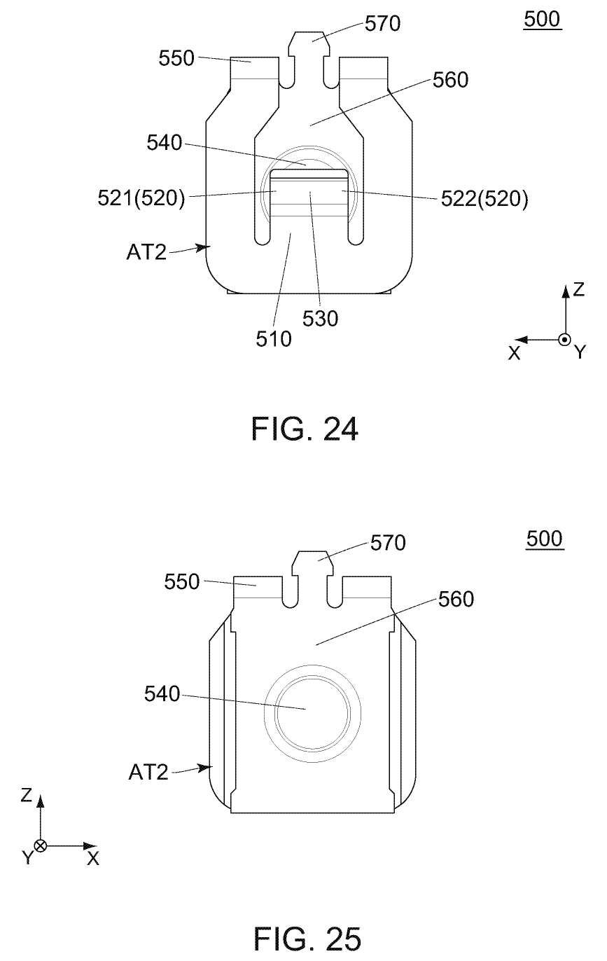

Referring to FIG. 24, each of the pressing members 500 of the present embodiment is made of metal. As shown in FIG. 4, each of the pressing members 500 is indirectly held by the second housing 210. However, the present invention is not limited thereto. Specifically, the pressing member 500 may be directly held by the second housing 210. In other words, the pressing member 500 should be directly or indirectly held by the second housing 210. The pressing members 500 correspond to the second contacts 400, respectively. The pressing members 500 correspond to the first contacts 120, respectively. Referring to FIGS. 4 and 11, at least in a state where the second contacting portion 410 is adjacent to the first contacting portion 122 in the second direction, a posture of the pressing member 500 is changeable between a first posture AT1 and a second posture AT2 by rotating the pressing member 500 about a predetermined axis 700. It is noted that the predetermined axis 700 extends in the second direction.

As shown in FIG. 23, each of the pressing members 500 has a spring portion 510 and two protruding portions 520. However, the present invention is not limited thereto. Specifically, the number of the protruding portion 520 may be one. Alternatively, the number of the protruding portions 520 may be three or more. In other words, the pressing member 500 should have the spring portion 510 and at least one protruding portion 520.

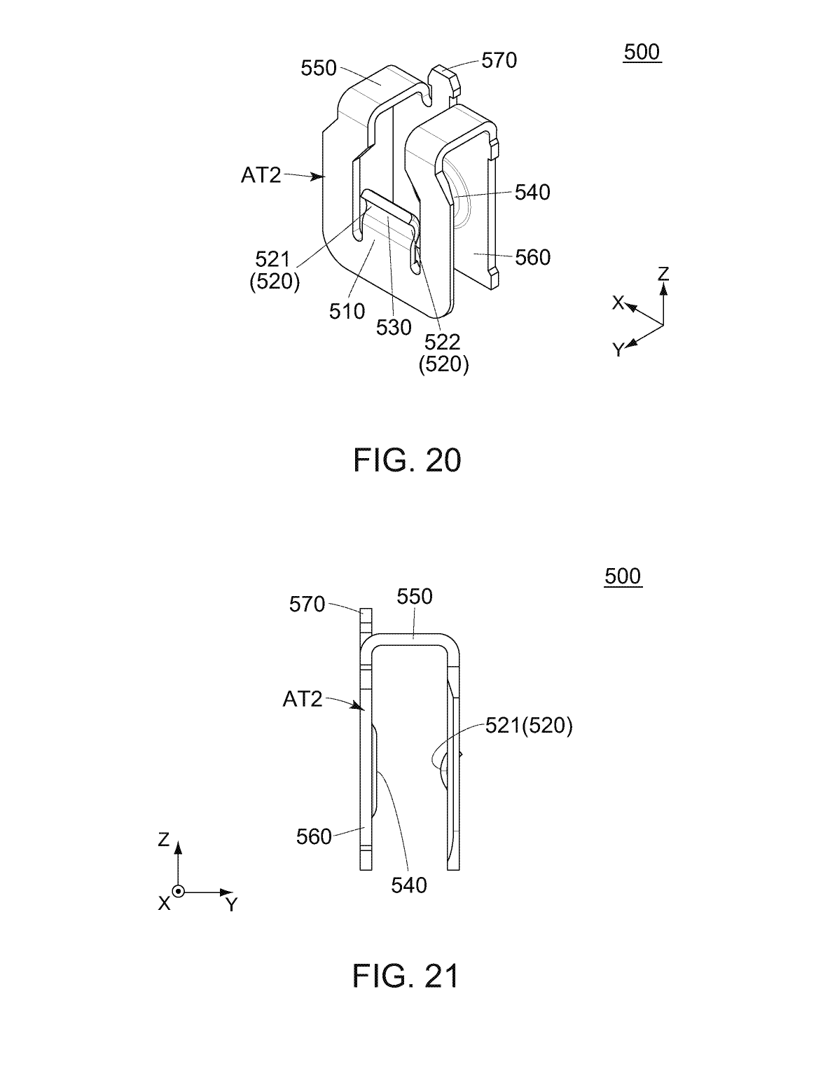

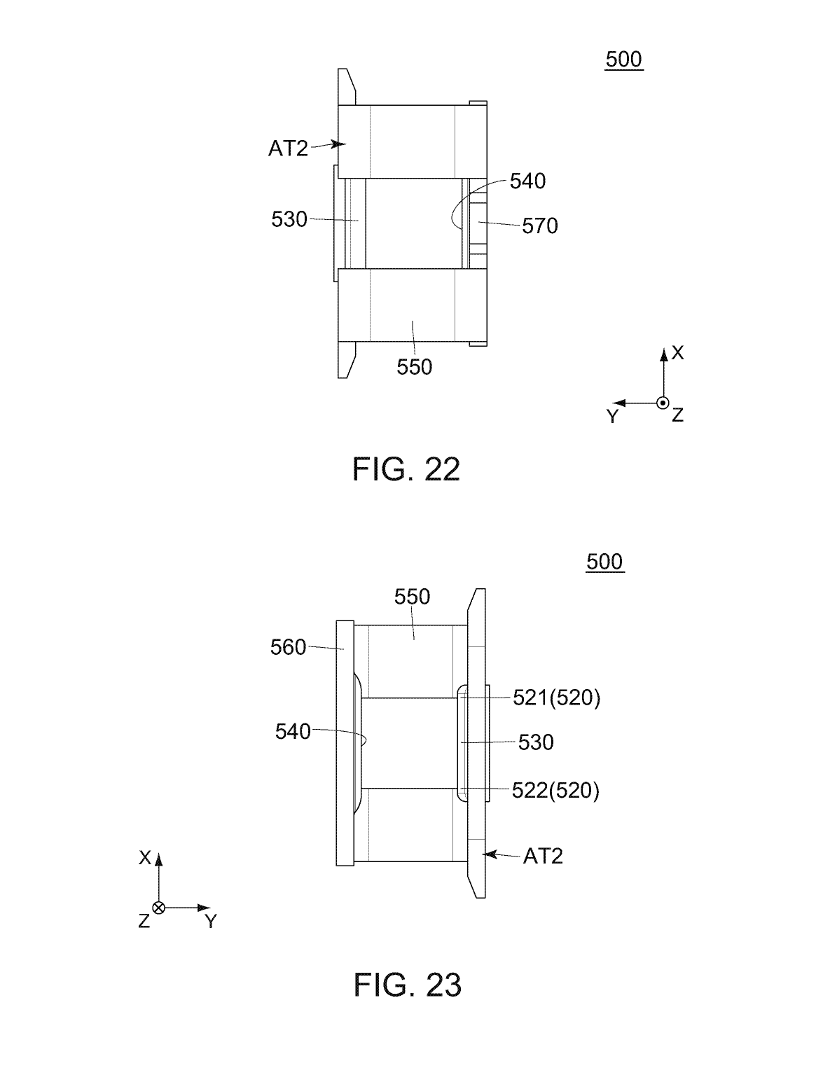

Referring to FIG. 20, the spring portion 510 of the present embodiment has a resilient property. As shown in FIG. 4, the spring portion 510 is located apart from the second contacting portion 410 in the second direction. The predetermined position PP is located between the spring portion 510 and the second contacting portion 410 in the second direction. In the second connector 200, a gap GP exists between the second contacting portion 410 and the spring portion 510 in the second direction. Specifically, the second connector 200 has two of the gaps GP. The gaps GP correspond to the first contacts 120, respectively.

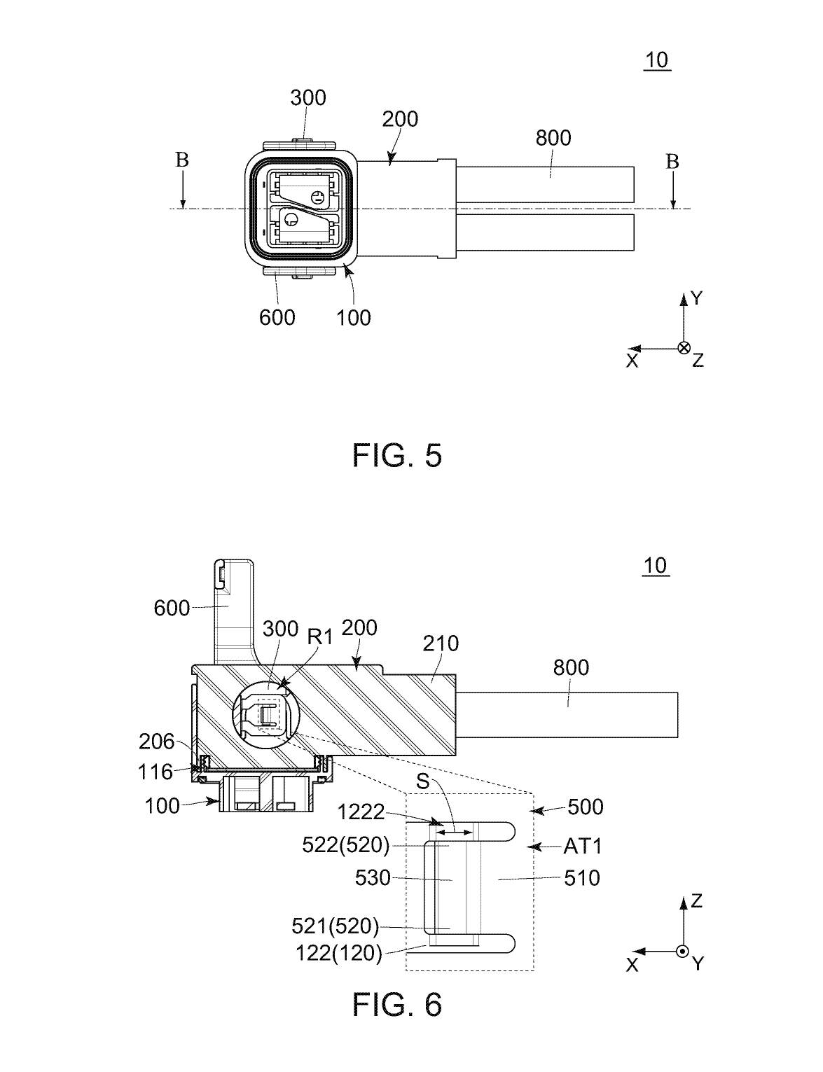

As shown in FIG. 12, each of the protruding portions 520 of the present embodiment has an arc-shaped cross-section in a plane perpendicular to the third direction when the posture of the pressing member 500 is the second posture AT2. As shown in FIG. 20, each of the protruding portions 520 is supported by the spring portion 510 and is movable in the second direction by using the resilient property of the spring portion 510. As shown in FIG. 4, each of the protruding portions 520 protrudes toward the second contacting portion 410 in the second direction. Referring to FIGS. 4, 11 and 12, together with the change of the posture of the pressing member 500, each of the protruding portions 520 is movable on a path, which is deviated from the predetermined axis 700, in a plane defined by the first direction and the third direction. Referring to FIGS. 1 and 4, when the second connector 200 is moved relative to the first connector 100 along the first direction in a state where the pressing member 500 assumes the first posture AT1 while a position of the groove 1222 matches a position of each of the protruding portions 520 in the plane defined by the second direction and the third direction, each of the protruding portions 520 is received in the groove 1222. More in detail, when the second connector 200 is moved relative to the first connector 100 along the first direction in the state where the pressing member 500 assumes the first posture AT1 while the position of the groove 1222 matches the position of each of the protruding portions 520 in the plane defined by the second direction and the third direction, each of the protruding portions 520 is, at least in part, received in the groove 1222. As shown in FIG. 4, each of the protruding portions 520 is located apart from the second contacting portion 410 of the second contact 400 in the second direction when the posture of the pressing member 500 is the first posture AT1. Each of the protruding portions 520 faces the groove 1222 of the first contact 120 in the second direction when the posture of the pressing member 500 is the first posture AT1. Referring to FIGS. 6 and 17, each of the protruding portions 520 does not ride on any of the pressed surfaces 1224 of the first contact 120 when the posture of the pressing member 500 is the first posture AT1. As shown in FIG. 12, each of the protruding portions 520 is in contact with the first contacting portion 122 of the first contact 120 in the second direction when the posture of the pressing member 500 is the second posture AT2. The protruding portions 520 ride on the pressed surfaces 1224, respectively, of the first contact 120 when the posture of the pressing member 500 is the second posture AT2. The protruding portions 520 ride on the pressed surfaces 1224, respectively, of the first contact 120 when the first connector 100 and the second connector 200 are mated with each other.

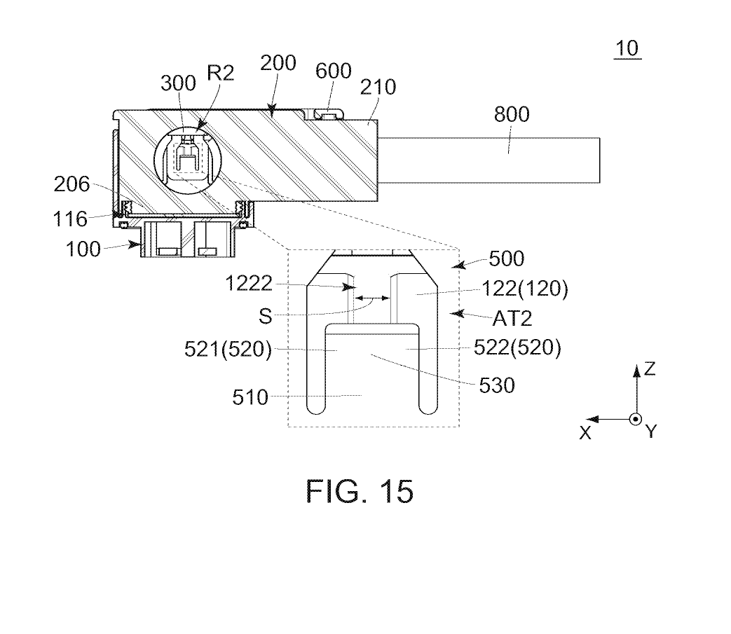

As shown in FIG. 24, the two protruding portions 520 include a first protruding portion 521 and a second protruding portion 522. As shown in FIG. 6, the first protruding portion 521 and the second protruding portion 522 are arranged in the first direction when the posture of the pressing member 500 is the first posture AT1. The first protruding portion 521 is located below the second protruding portion 522 in the up-down direction when the posture of the pressing member 500 is the first posture AT1. As shown in FIG. 15, the first protruding portion 521 and the second protruding portion 522 are arranged in the third direction when the posture of the pressing member 500 is the second posture AT2. The first protruding portion 521 is located forward of the second protruding portion 522 in the front-rear direction when the posture of the pressing member 500 is the second posture AT2.

As shown in FIG. 24, the pressing member 500 has a coupling portion 530.

As shown in FIG. 4, the coupling portion 530 of the present embodiment protrudes toward the second contacting portion 410 in the second direction. As shown in FIG. 6, the coupling portion 530 is located between the two protruding portions 520. The coupling portion 530 couples the two protruding portions 520 with each other. The coupling portion 530 and the two protruding portions 520 are linearly arranged in the first direction when the posture of the pressing member 500 is the first posture AT1. This facilitates formation of the protruding portions 520 and the coupling portion 530 of the pressing member 500 of the present embodiment. It is noted that a size of the coupling portion 530 in the third direction is the same as a size of any of the protruding portions 520 in the third direction when the posture of the pressing member 500 is the first posture AT1.

Referring to FIGS. 1 and 4, the coupling portion 530 is received in the groove 1222 when the second connector 200 is moved relative to the first connector 100 along the first direction in the state where the pressing member 500 assumes the first posture AT1 while the position of the groove 1222 matches the position of each of the protruding portions 520 in the plane defined by the second direction and the third direction. More in detail, the coupling portion 530 is, at least in part, received in the groove 1222 when the second connector 200 is moved relative to the first connector 100 along the first direction in the state where the pressing member 500 assumes the first posture AT1 while the position of the groove 1222 matches the position of each of the protruding portions 520 in the plane defined by the second direction and the third direction. As shown in FIG. 4, the coupling portion 530 faces the groove 1222 in the second direction when the posture of the pressing member 500 is the first posture AT1. Referring to FIGS. 6 and 17, the coupling portion 530 does not ride on any of the pressed surfaces 1224 of the first contact 120 when the posture of the pressing member 500 is the first posture AT1. As shown in FIG. 11, the coupling portion 530 has an arc-shaped cross-section in the plane perpendicular to the third direction when the posture of the pressing member 500 is the second posture AT2. The coupling portion 530 faces the groove 1222 of the first contact 120 in the second direction when the posture of the pressing member 500 is the second posture AT2. As shown in FIG. 15, the coupling portion 530 and the two protruding portions 520 are linearly arranged in the third direction when the posture of the pressing member 500 is the second posture AT2. Referring to FIGS. 15 and 17, the coupling portion 530 does not ride on any of the pressed surfaces 1224 of the first contact 120 when the posture of the pressing member 500 is the second posture AT2.

Referring to FIG. 4, in a state where the second contacting portion 410 is adjacent to the first contacting portion 122, the coupling portion 530 is located on the predetermined axis 700 in the plane defined by the first direction and the third direction. It is noted that, in the state where the second contacting portion 410 is adjacent to the first contacting portion 122, the groove 1222 is located on the predetermined axis 700 in the plane defined by the first direction and the third direction.

As shown in FIG. 25, each of the pressing members 500 further has a receiving portion 540. However, the present invention is not limited thereto. Specifically, the pressing member 500 may have no receiving portion 540.

As shown in FIG. 25, the receiving portion 540 of the present embodiment is circular. As shown in FIG. 20, the receiving portion 540 is located apart from the spring portion 510 in the second direction. As shown in FIG. 4, the second contacting portion 410 is located between the spring portion 510 and the receiving portion 540 in the second direction. The receiving portion 540 is located on the predetermined axis 700 in a plane perpendicular to the second direction. A center of the circle of the receiving portion 540 in the plane perpendicular to the second direction is located on the predetermined axis 700. The second contacting portion 410 of the second contact 400 is in contact with the receiving portion 540 in the second direction when the posture of the pressing member 500 is the first posture AT1. As shown in FIG. 11, the second contacting portion 410 of the second contact 400 is in contact with the receiving portion 540 in the second direction when the posture of the pressing member 500 is the second posture AT2. The second contacting portion 410 of the second contact 400 is in contact with the receiving portion 540 in the second direction when the first connector 100 and the second connector 200 are mated with each other. As shown in FIG. 12, both of the first contacting portion 122 and the second contacting portion 410 are sandwiched between each of the protruding portions 520 and the receiving portion 540 when the posture of the pressing member 500 is the second posture AT2. Both of the first contacting portion 122 and the second contacting portion 410 are sandwiched between each of the protruding portions 520 and the receiving portion 540 when the first connector 100 and the second connector 200 are mated with each other.

As shown in FIG. 25, each of the pressing members 500 has a connection portion 550, a base portion 560 and a press-fitting portion 570.

As shown in FIG. 20, the connection portion 550 of the present embodiment connects the spring portion 510 and the base portion 560 with each other. The connection portion 550 is bent from the spring portion 510 so that it extends outward in the second direction, and is bent so that it extends to the base portion 560. More in detail, when the posture of the pressing member 500 is the second posture AT2, the connection portion 550 is bent from the spring portion 510 so that it extends outward in the second direction, and is bent so that it extends downward in the up-down direction to reach the base portion 560.

As shown in FIG. 23, the base portion 560 of the present embodiment has a flat-plate shape. The receiving portion 540 protrudes inward in the second direction from the base portion 560. The receiving portion 540 protrudes from the base portion 560 toward the protruding portions 520 in the second direction. The receiving portion 540 protrudes from the base portion 560 toward the coupling portion 530 in the second direction.

As shown in FIG. 25, the press-fitting portion 570 of the present embodiment extends outward from the base portion 560 in the plane perpendicular to the second direction. The press-fitting portion 570 extends upward in the up-down direction from the base portion 560 when the posture of the pressing member 500 is the second posture AT2.

As shown in FIG. 19, the second connector 200 further comprises a shaft 300.

Referring to FIG. 19, the shaft 300 of the present embodiment is made of insulator. More in detail, the shaft 300 is made of resin. The shaft 300 has a center 310 of rotation. The predetermined axis 700 is the center 310 of rotation of the shaft 300. As shown in FIG. 4, each of the protruding portions 520 is deviated from the center 310 of rotation in the plane perpendicular to the second direction. The coupling portion 530 is located on the center 310 of rotation in the plane perpendicular to the second direction. The receiving portion 540 is located on the center 310 of rotation in the plane perpendicular to the second direction. The center of the circle of the receiving portion 540 in the plane perpendicular to the second direction is located on the center 310 of rotation.

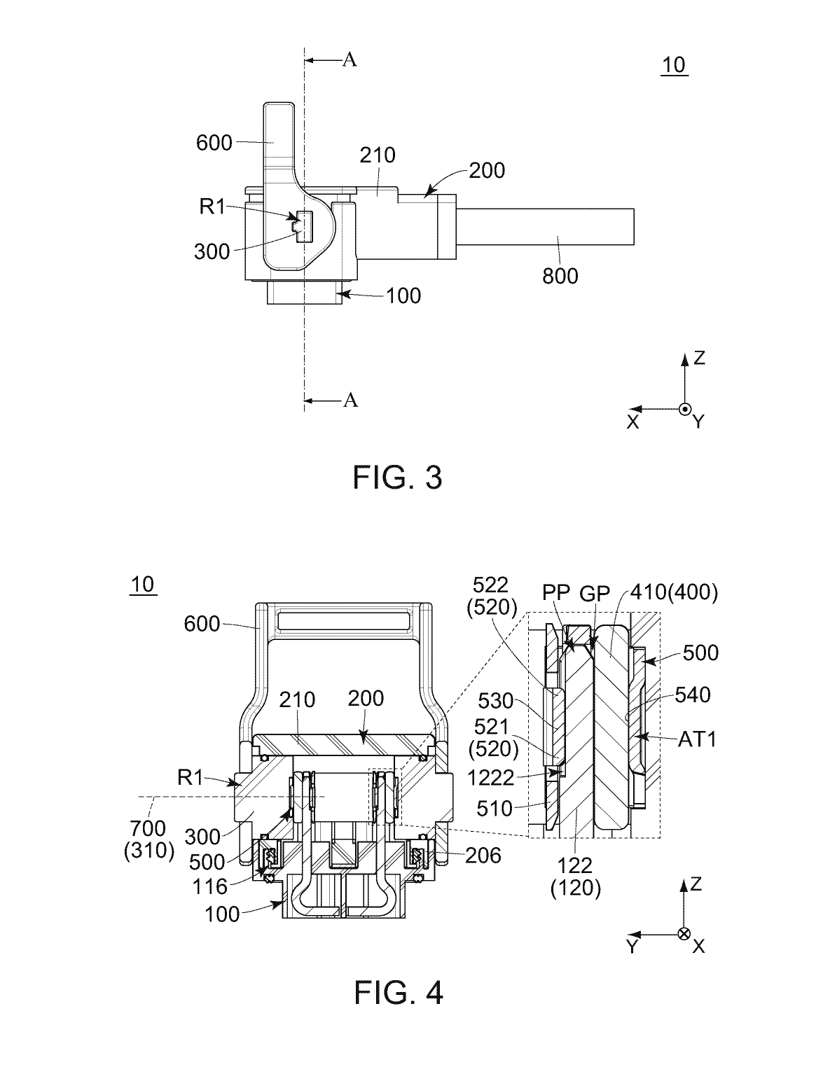

As understood from FIGS. 3 and 10, the shaft 300 is held by the second housing 210 so as to be rotatable between a first rotation position R1 and a second rotation position R2. The shaft 300 is rotatable by 90° between the first rotation position R1 and the second rotation position R2. As shown in FIG. 6, the pressing member 500 assumes the first posture AT1 when the shaft 300 is located at the first rotation position R1. As shown in FIG. 15, the pressing member 500 assumes the second posture AT2 when the shaft 300 is located at the second rotation position R2.

As described above, the connector structure 10 of the present embodiment is configured so that each of the second contacts 400 is directly held by the second housing 210. If the connector structure 10 is modified so that the second contact 400 is not directly held by the second housing 210 while the second contact 400 is held by the shaft 300 or is rotatable together with the shaft 300, the modified connector structure 10 has a drawback as follows: the second housing 210 must be formed of two parts and thereby the modified connector structure 10 has a complicated configuration; and, when the second contact 400 is rotated together with the shaft 300, the second contacting portion 410 takes various positions in the plane perpendicular to the second direction.

In contrast, the connector structure 10 of the present embodiment is configured so that each of the second contacts 400 is directly held by the second housing 210. This enables the connector structure 10 of the present embodiment to be configured so that the second housing 210 has a simplified configuration while the second contacting portion 410 takes a stable position in the plane, which is perpendicular to the second direction, regardless of the rotation of the shaft 300. Accordingly, in the connector structure 10 of the present embodiment, the second contact 400 can be brought into reliable contact with the first contact 120 when the first connector 100 and the second connector 200 are mated with each other. Thus, the second contact 400 is more preferred to be directly held by the second housing 210 similar to those of the connector structure 10 of the present embodiment.

Referring to FIGS. 4 and 11, the second contacting portion 410 is in non-contact with the shaft 300 when the first connector 100 and the second connector 200 are mated with each other. The second contacting portion 410 of the second contact 400 is in non-contact with the shaft 300 regardless of the position of the shaft 300.

As shown in FIG. 4, each of the pressing members 500 is held by the shaft 300. Specifically, each of the pressing members 500 is directly held by the shaft 300. Each of the pressing members 500 is press-fit into the shaft 300. More in detail, referring to FIGS. 4 and 19, the press-fitting portions 570 of the pressing members 500 are press-fit into press-fit portions 320, respectively, of the shaft 300. This prevents movements of the pressing members 500 relative to the shaft 300 in the plane perpendicular to the second direction.

Referring to FIGS. 6 and 15, each of the pressing members 500 is movable together with the rotation of the shaft 300. Specifically, each of the pressing members 500 is movable together with the rotation of the shaft 300 when the shaft 300 is rotated about the center 310 of rotation as shown in FIG. 19. Referring to FIGS. 4 and 12, when the shaft 300 is rotated from the first rotation position R1 to the second rotation position R2 in the state where the second contacting portion 410 is adjacent to the first contacting portion 122, the posture of each of the pressing members 500 is changed from the first posture AT1 to the second posture AT2. As shown in FIG. 4, when the shaft 300 is located at the first rotation position R1, each of the protruding portions 520 is located at a position which is deviated from the center 310 of rotation of the shaft 300 in the plane perpendicular to the second direction. Specifically, when the pressing member 500 assumes the first posture AT1, each of the protruding portions 520 is located at the position which is deviated from the center 310 of rotation of the shaft 300 in the plane perpendicular to the second direction. Referring to FIGS. 11 and 12, when the shaft 300 is located at the second rotation position R2, each of the protruding portions 520 is located at a position which is deviated from the center 310 of rotation of the shaft 300 in the plane perpendicular to the second direction. Specifically, when the pressing member 500 assumes the second posture AT2, each of the protruding portions 520 is located at the position which is deviated from the center 310 of rotation of the shaft 300 in the plane perpendicular to the second direction.

As described above, each of the pressing members 500 of the present embodiment has the protruding portions 520 and the receiving portion 540. Accordingly, even if the connector structure 10 has a variety of positions of the pressing member 500 relative to the shaft 300 upon assembling of the pressing member 500 to the shaft 300, the connector structure 10 can have a constant distance between each of the protruding portions 520 and the receiving portion 540 when the posture of the pressing member 500 is the second posture AT2. As described above, both of the first contacting portion 122 and the second contacting portion 410 are sandwiched between each of the protruding portions 520 and the receiving portion 540 when the posture of the pressing member 500 is the second posture AT2. Accordingly, the connector structure 10 of the present embodiment has an advantage as follows: without being affected by the variety of the positions of the pressing member 500, the first contacting portion 122 and the second contacting portion 410 can make reliable contact with each other by sandwiching both of the first contacting portion 122 and the second contacting portion 410 between each of the protruding portions 520 and the receiving portion 540 when the posture of the pressing member 500 is the second posture AT2.

If the connector structure 10 is used in high-current applications, this use increases an amount of heat produced at a contact part of the first contacting portion 122 and the second contacting portion 410. Accordingly, from a point of view of heat dissipation or the like, the connector structure 10 for high-current applications is more preferred to have a configuration as follows: when the first connector 100 and the second connector 200 are mated with each other, the second contacting portion 410 is brought into contact not with the shaft 300 made of resin, but with a member made of metal. As described above, the connector structure 10 of the present embodiment is configured so that, when the first connector 100 and the second connector 200 are mated with each other, the second contacting portion 410 is brought into contact, not with the shaft 300 made of resin, but with the receiving portion 540 of the pressing member 500 made of metal. Accordingly, the present embodiment is more preferred if the connector structure 10 is used in high-current applications.

As described above, the shaft 300 is held by the second housing 210 so as to be rotatable while each of the pressing members 500 is held by the shaft 300. Accordingly, each of the pressing members 500 is movable relative to the second housing 210 in the plane perpendicular to the second direction.

As shown in FIG. 1, the second connector 200 has a mating portion 206.

As shown in FIG. 1, the mating portion 206 of the present embodiment defines the other end of the second connector 200 in the first direction. Specifically, the mating portion 206 defines the lower end of the second connector 200 in the up-down direction. Referring to FIGS. 1 and 2, the mating portion 206 is accommodated in the mating portion accommodating portion 116 when the first connector 100 and the second connector 200 are mated with each other.

As shown in FIG. 19, the connector structure 10 further comprises a lever 600. More in detail, the lever 600 is provided on the second connector 200. However, the present invention is not limited thereto. Specifically, the connector structure 10 may comprise no lever 600.

Referring to FIGS. 3 and 10, the lever 600 is used for operating the rotation of the shaft 300. The lever 600 is attached to the shaft 300. The shaft 300 is rotatable by 90° by operating the lever 600.

Hereinafter, a detailed description will be made about an operation of mating the first connector 100 with the second connector 200.

First, referring to FIG. 1, the second connector 200, whose shaft 300 is located at the first rotation position R1, is located above the first connector 100 in the up-down direction while the position of the groove 1222 matches the position of each of the protruding portions 520 in the plane defined by the second direction and the third direction. This state is referred to as a pre-mated state. It is noted that, in the pre-mated state, the posture of each of the pressing members 500 is the first posture AT1.

From the pre-mated state, the second connector 200 is moved relative to the first connector 100 along the first direction. Specifically, the second connector 200 is moved downward in the up-down direction relative to the first connector 100. Then, the mating portion accommodating portion 116 of the first connector 100 partially accommodates the mating portion 206 of the second connector 200. At this time, the first housing 110 regulates the movement of the second housing 210 in the plane defined by the second direction and the third direction. More in detail, at this time, the regulating portion 114 regulates the movement of the regulated portion 214 in the plane defined by the second direction and the third direction.

After that, the second connector 200 is further moved relative to the first connector 100 along the first direction. Specifically, the second connector 200 is further moved downward in the up-down direction relative to the first connector 100. Then, the first contacting portion 122 is inserted between the second contacting portion 410 and the spring portion 510 while the first housing 110 regulates the movement of the second housing 210 in the plane defined by the second direction and the third direction. More in detail, the first contacting portion 122 of the first contact 120 of the first connector 100 is inserted into the corresponding gap GP of the second connector 200 while the regulating portion 114 regulates the movement of the regulated portion 214 in the plane defined by the second direction and the third direction.

After that, the second connector 200 is yet further moved relative to the first connector 100 along the first direction. Specifically, the second connector 200 is yet further moved downward in the up-down direction relative to the first connector 100. Then, while the first housing 110 regulates the movement of the second housing 210 in the plane defined by the second direction and the third direction, each of the protruding portions 520 is received in the groove 1222 and is moved in the groove 1222, and the second contacting portion 410 becomes adjacent to the first contacting portion 122. More in detail, while the regulating portion 114 regulates the movement of the regulated portion 214 in the plane defined by the second direction and the third direction, the two protruding portions 520 and the coupling portion 530 of the pressing member 500 of the second connector 200 are received in the groove 1222 of the corresponding first contact 120 of the first connector 100 and are moved downward in the groove 1222, and the second contacting portion 410 becomes adjacent to the first contacting portion 122. Accordingly, the connector structure 10 changes its state from the pre-mated state to a ZIF insertion state shown in each of FIGS. 2 to 6.

Summarizing the above, when the second connector 200 is moved relative to the first connector 100 along the first direction in the state where the pressing member 500 assumes the first posture AT1 while the position of the groove 1222 matches the position of the protruding portion 520 in the plane defined by the second direction and the third direction, the first contacting portion 122 is inserted between the second contacting portion 410 and the spring portion 510 while the protruding portion 520 is received in the groove 1222, and the second contacting portion 410 becomes adjacent to the first contacting portion 122. Accordingly, in the connector structure 10 of the present embodiment, the second contact 400 of the second connector 200 can be inserted into the first connector 100 with zero insertion force when the second connector 200 approaches the first connector 100 in a state where the posture of the pressing member 500 is the first posture AT1. Additionally, the first housing 110 guides the second housing 210 until the protruding portion 520 is moved in the groove 1222 and the second contacting portion 410 comes to be located adjacent to the first contacting portion 122 while the first housing 110 regulates the movement of the second housing 210 in the plane defined by the second direction and the third direction.

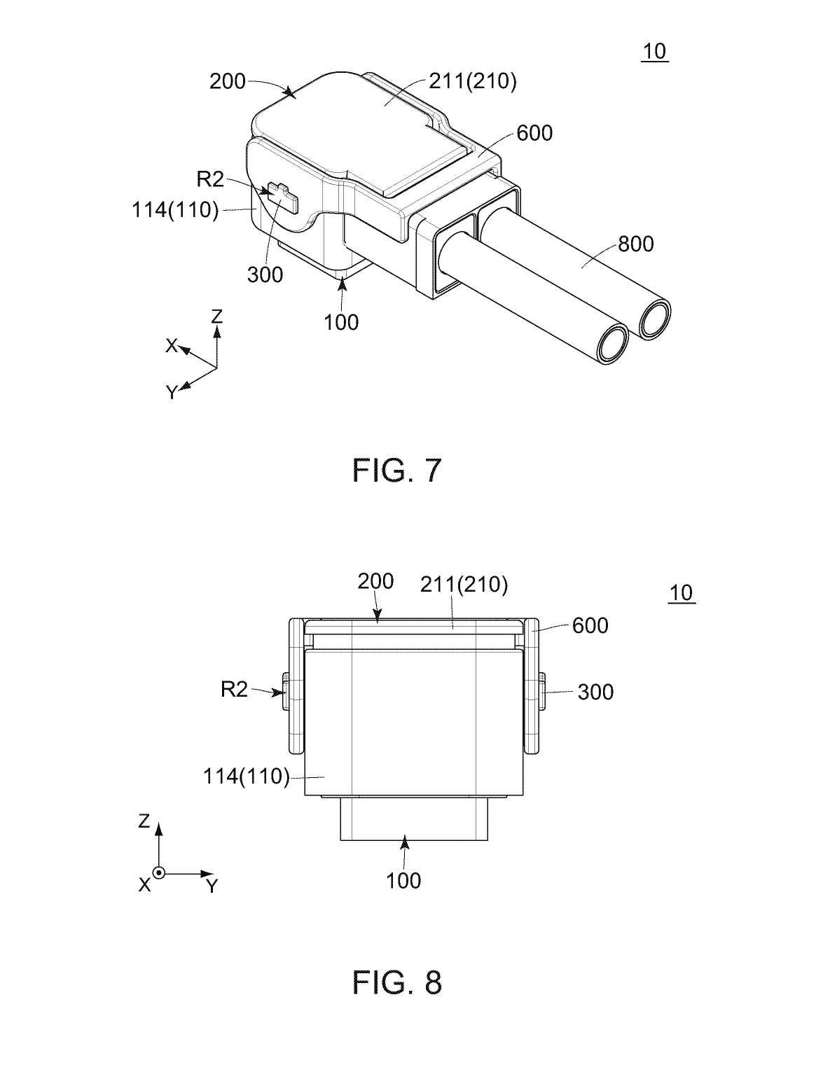

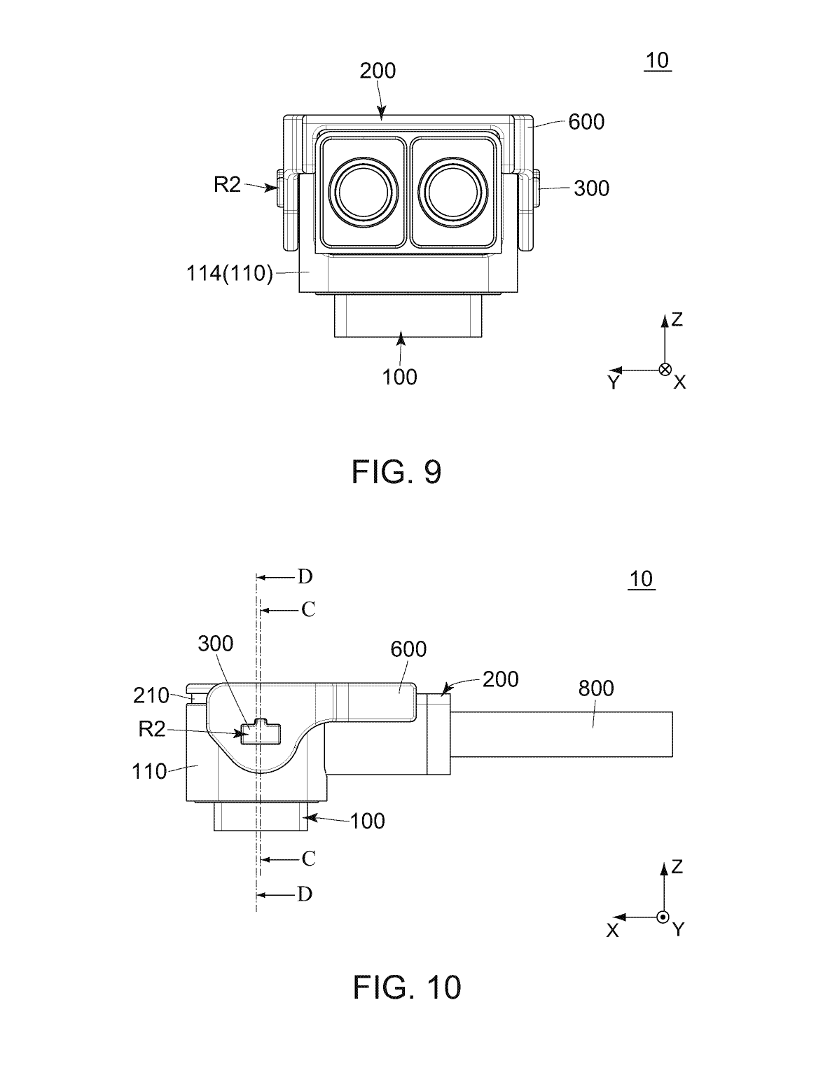

In the connector structure 10 taking the ZIF insertion state, the shaft 300 is rotated from the first rotation position R1 to the second rotation position R2 by tilting the lever 600 rearward. Then, the posture of the pressing member 500 is changed from the first posture AT1 to the second posture AT2. At this time, the first protruding portion 521 is moved forward and out of the groove 1222 so that the first protruding portion 521 rides on the first pressed surface 1225. Also, at this time, the second protruding portion 522 is moved rearward and out of the groove 1222 so that the second protruding portion 522 rides on the second pressed surface 1226. Accordingly, the connector structure 10 changes its state from the ZIF insertion state to a mated state shown in each of FIGS. 7 to 15. In the mated state, the protruding portions 520 press the pressed surfaces 1224, respectively, by using the resilient property of the spring portion 510 and thereby press the first contacting portion 122 against the second contacting portion 410. More in detail, in the mated state, the first protruding portion 521 presses the first pressed surface 1225 by using the resilient property of the spring portion 510 while the second protruding portion 522 presses the second pressed surface 1226 by using the resilient property of the spring portion 510. This causes the first protruding portion 521 and the second protruding portion 522 to press the first contacting portion 122 against the protrusions 412 of the second contacting portion 410 in the mated state. It is noted that, in the mated state, the coupling portion 530 does not ride on any of the pressed surfaces 1224 and is located inward of the groove 1222 in the second direction.

Summarizing the above, when the posture of the pressing member 500 is changed from the first posture AT1 to the second posture AT2 in the state where the second contacting portion 410 is adjacent to the first contacting portion 122 while the protruding portion 520 is located in the groove 1222, the protruding portion 520 is moved out of the groove 1222 to ride on the pressed surface 1224, and the protruding portion 520 presses the pressed surface 1224 by using the resilient property of the spring portion 510 and thereby presses the first contacting portion 122 against the second contacting portion 410. Accordingly, the connector structure 10 of the present embodiment is configured as follows: when the posture of the pressing member 500 is changed from the first posture AT1 to the second posture AT2 after the second contact 400 of the second connector 200 is inserted into the first connector 100 with zero insertion force, the protruding portion 520 of the pressing member 500 presses the pressed surface 1224 of the first contact 120, and thereby the first contacting portion 122 of the first contact 120 and the second contacting portion 410 of the second contact 400 are connected to each other. Thus, the connector structure 10 of the present embodiment can reduce operating force upon the mating of the first connector 100 and the second connector 200 without increasing a size of the connector structure 10.

As described above, the lever 600, which is used for operating the rotation of the shaft 300, is attached to the shaft 300. Accordingly, by using the principle of leverage, the connector structure 10 of the present embodiment further reduces the operating force upon the mating of the first connector 100 and the second connector 200.

As described above, in the state where the second contacting portion 410 is adjacent to the first contacting portion 122, the coupling portion 530 is located on the predetermined axis 700 in the plane defined by the first direction and the third direction. Accordingly, the connector structure 10 of the present embodiment yet further reduces the operating force upon the mating of the first connector 100 and the second connector 200.

Although the connector structure 10 of the present embodiment is configured so that the shaft 300 is rotatable by 90°, the present invention is not limited thereto. Specifically, the rotatable range of the shaft 300 may be less than 90°, provided that the connector structure 10 has a configuration as follows: when the second connector 200 is moved relative to the first connector 100 along the first direction in the state where the pressing member 500 assumes the first posture AT1 while the position of the groove 1222 matches the position of the protruding portion 520 in the plane defined by the second direction and the third direction, the first contacting portion 122 is inserted between the second contacting portion 410 and the spring portion 510 while the protruding portion 520 is received in the groove 1222, and the second contacting portion 410 becomes adjacent to the first contacting portion 122; and, when the posture of the pressing member 500 is changed from the first posture AT1 to the second posture AT2 in the state where the second contacting portion 410 is adjacent to the first contacting portion 122 while the protruding portion 520 is located in the groove 1222, the protruding portion 520 is moved out of the groove 1222 to ride on the pressed surface 1224, and the protruding portion 520 presses the pressed surface 1224 by using the resilient property of the spring portion 510 and thereby presses the first contacting portion 122 against the second contacting portion 410.

### Second embodiment

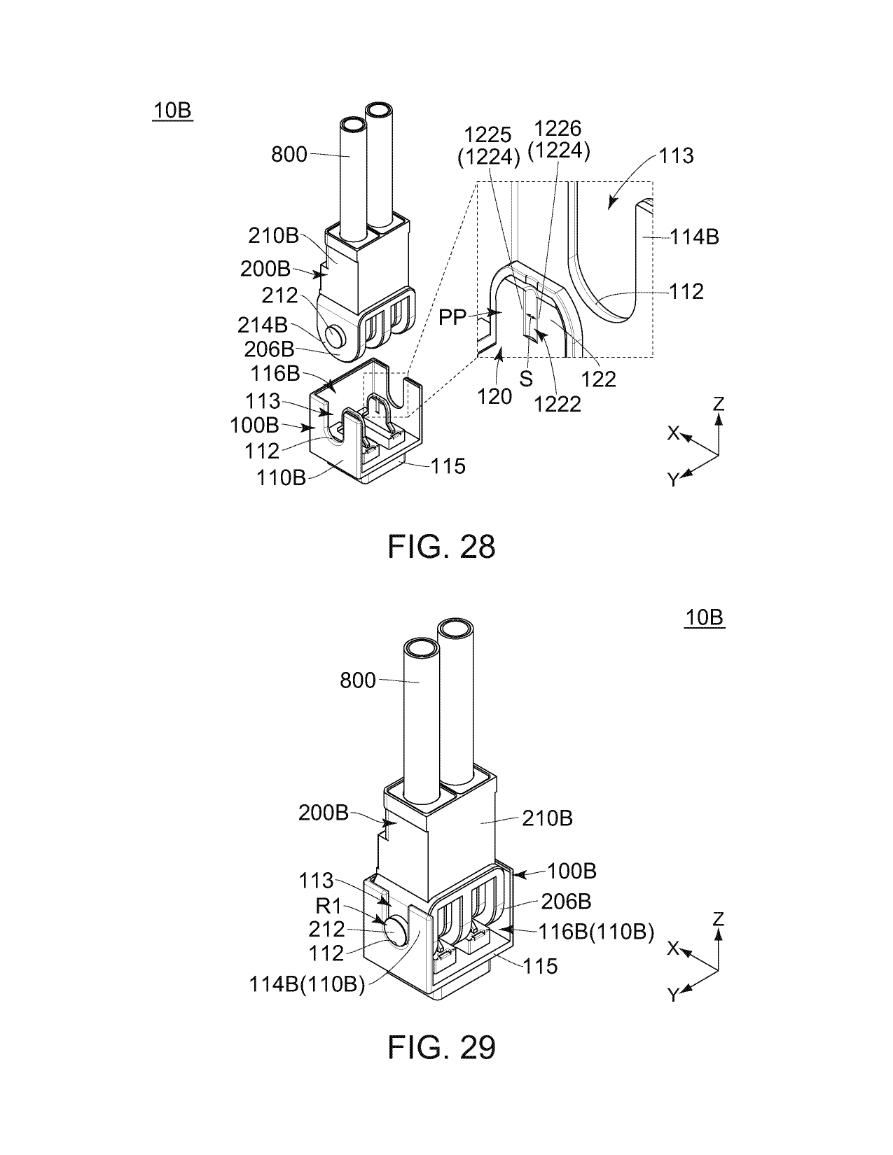

Referring to FIG. 28, a connector structure 10B according to a second embodiment of the present invention comprises a first connector 100B and a second connector 200B. Referring to FIGS. 28 and 29, the first connector 100B and the second connector 200B are mateable with each other along the first direction. The connector structure 10B of the present embodiment is used for a high-current power supply. However, the present invention is not limited thereto. Specifically, the connector structure 10B may also be used for another application. The connector structure 10B according to the present embodiment has a structure similar to that of the connector structure 10 according to the aforementioned first embodiment as shown in FIG. 1. Components of the connector structure 10B shown in FIGS. 28 to 36 which are same as those of the connector structure 10 of the first embodiment are referred to by using reference signs same as those of the connector structure 10 of the first embodiment. As for directions and orientations in the present embodiment, expressions same as those of the first embodiment will be used hereinbelow.

As shown in FIG. 28, the first connector 100B of the present embodiment comprises a first housing 110B and two first contacts 120. Each of the first contacts 120 has a first contacting portion 122 with a flat-plate shape. The first contact 120 of the present embodiment has a structure same as that of the first contact 120 of the first embodiment. Accordingly, a detailed explanation thereabout is omitted.

Referring to FIG. 28, the first housing 110B of the present embodiment is made of insulator. The first housing 110B is provided with bearings 112.

As shown in FIG. 28, the bearings 112 of the present embodiment are located at opposite ends, respectively, of the first housing 110B in the second direction.

As shown in FIG. 28, the first housing 110B is provided with channels 113.

As shown in FIG. 28, each of the channels 113 of the present embodiment opens at its one end in the first direction. Specifically, each of the channels 113 opens at its upper end in the up-down direction. Each of the channels 113 is located at the opposite ends, respectively, of the first housing 110B in the second direction. The channel 113 extends in the first direction from the bearing 112. Specifically, the channel 113 extends upward in the up-down direction from the bearing 112. The channels 113 correspond to the bearings 112, respectively. Each of the channels 113 extends upward in the up-down direction from the corresponding bearing 112.

As shown in FIG. 28, the first housing 110B has a regulating portion 114B, a bottom portion 115 and a mating portion accommodating portion 116B. The bottom portion 115 of the present embodiment has a structure same as that of the bottom portion 115 of the first embodiment. Accordingly, a detailed explanation thereabout is omitted.

Referring to FIG. 28, the regulating portion 114B of the present embodiment extends in the first direction from the bottom portion 115. Specifically, the regulating portion 114B extends upward in the up-down direction from the bottom portion 115. The regulating portion 114B defines an end of the first housing 110B in the first direction. Specifically, the regulating portion 114B defines an upper end of the first housing 110B in the up-down direction. The regulating portion 114B defines the opposite ends of the first housing 110B in the second direction. The bearing 112 pierces the regulating portion 114B in the second direction. The channel 113 pierces the regulating portion 114B in the second direction.

Referring to FIG. 28, the mating portion accommodating portion 116B of the present embodiment opens at its one end in the first direction. Specifically, the mating portion accommodating portion 116B opens at its upper end in the up-down direction. The mating portion accommodating portion 116B opens at its rear end in the front-rear direction. The bearing 112 communicates with the mating portion accommodating portion 116B in the second direction. The channel 113 communicates with the mating portion accommodating portion 116B in the second direction. The mating portion accommodating portion 116B is located above the bottom portion 115 in the up-down direction.

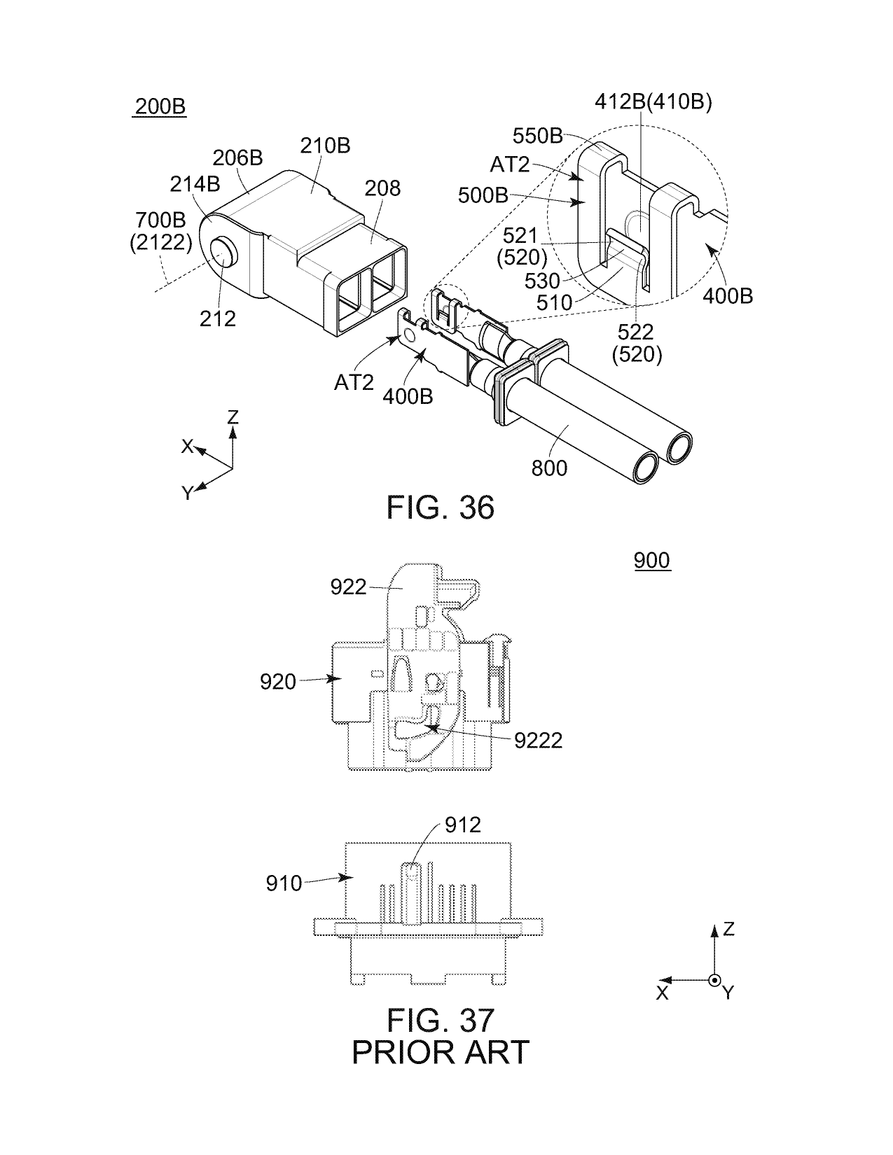

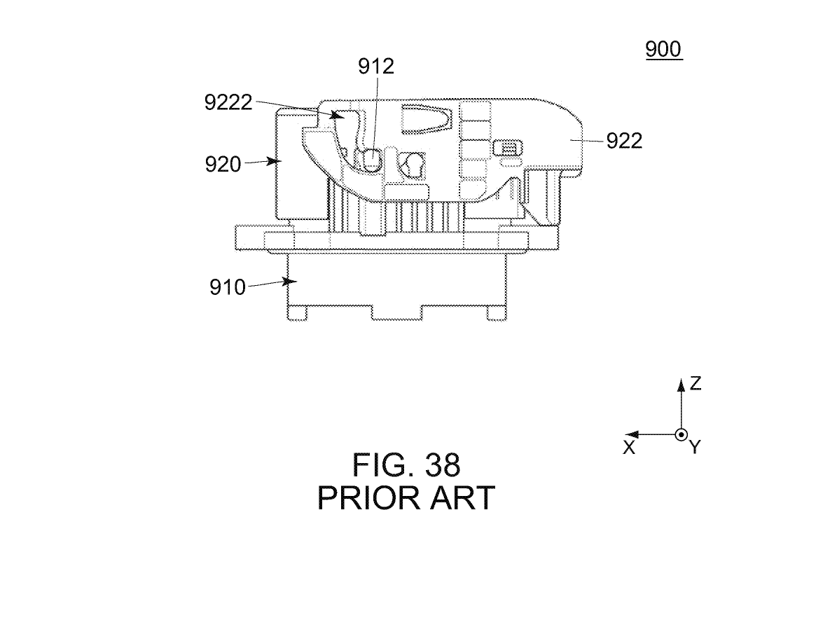

Referring to FIG. 36, the second connector 200B of the present embodiment comprises a second housing 210B, two second contacts 400B and two pressing members 500B. However, the present invention is not limited thereto. Specifically, the number of each of the second contact 400B and the pressing member 500B may be one. In other words, the second connector 200B should comprise the second housing 210B, the single second contact 400B and the single pressing member 500B.

Referring to FIG. 36, the second housing 210B of the present embodiment is made of insulator. The second housing 210B is provided with axis portions 212.

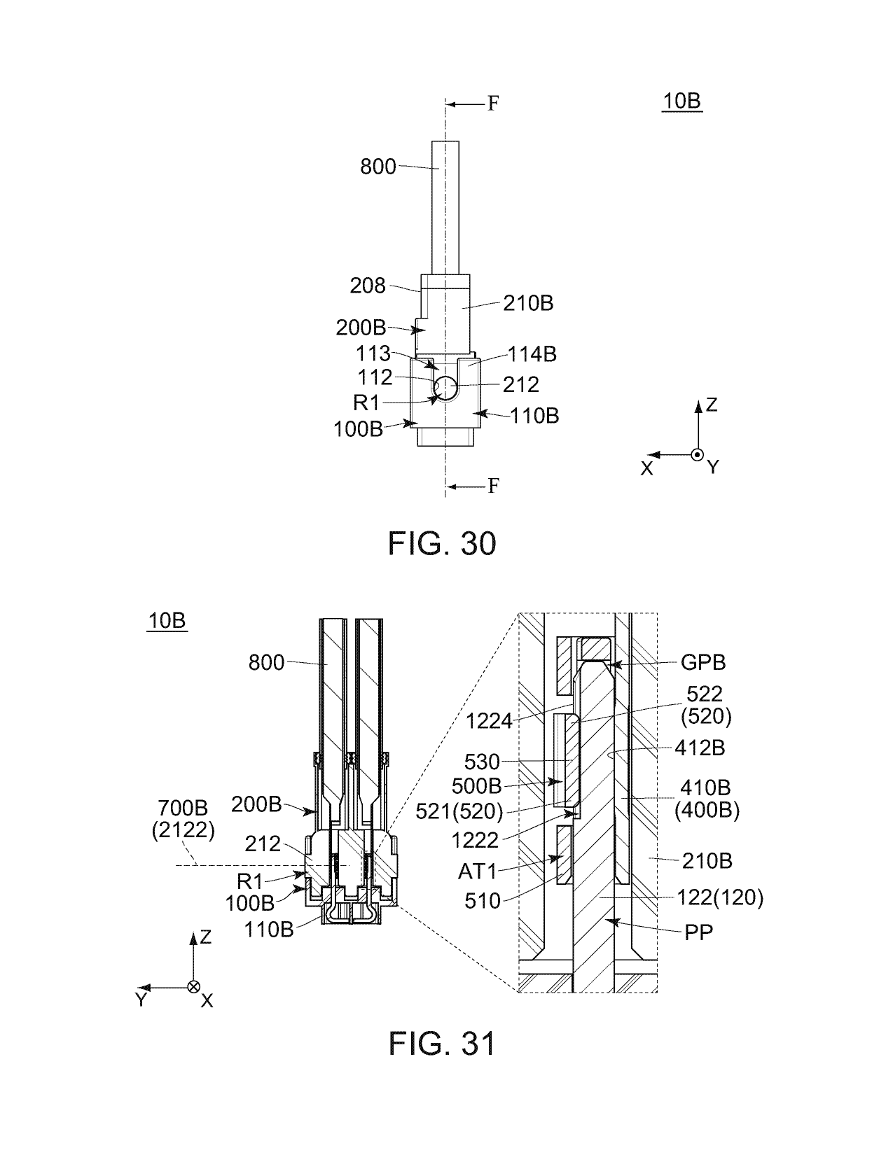

As shown in FIG. 36, each of the axis portions 212 of the present embodiment protrudes outward in the second direction. The axis portion 212 defines an outer end of the second housing 210B in the second direction. Each of the axis portions 212 has a center 2122 of rotation. Referring to FIGS. 30 and 33, the second housing 210B is rotatable between a first rotation position R1 and a second rotation position R2 when the axis portions 212 are supported by the bearings 112, respectively. The second housing 210B is rotatable by 90° between the first rotation position R1 and the second rotation position R2.

As shown in FIG. 36, the second housing 210B has regulated portions 214B.

Referring to FIG. 36, the regulated portions 214B of the present embodiment correspond to the axis portions 212, respectively. Each of the regulated portions 214B is located inward of the corresponding axis portion 212 in the second direction. Referring to FIGS. 28 and 29, the regulating portion 114B regulates movements of the regulated portions 214B in the second direction when the first connector 100B and the second connector 200B are mated with each other.

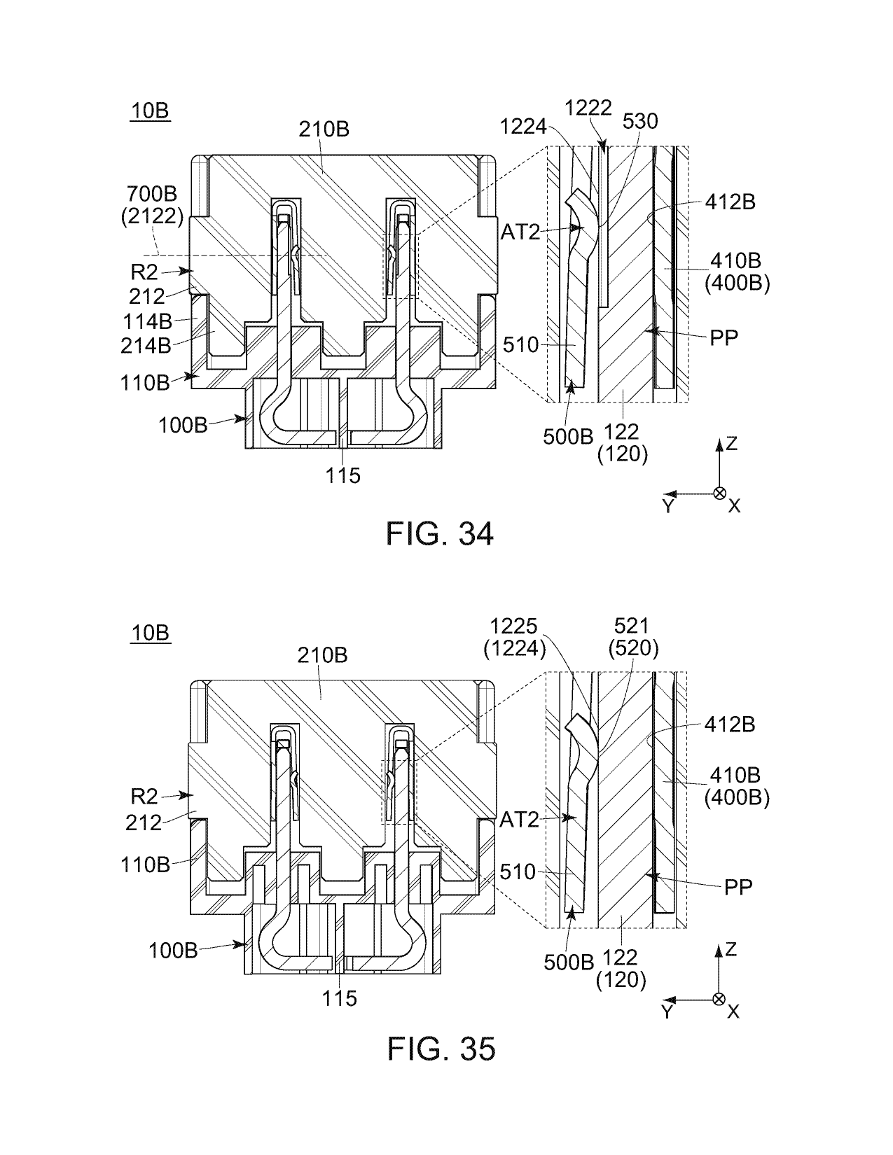

Referring to FIG. 36, each of the second contacts 400B of the present embodiment is made of metal. The second contact 400B and the pressing member 500B are integrally formed with each other. The second contacts 400B correspond to the pressing members 500B, respectively. Specifically, the second contact 400B and the corresponding pressing member 500B are integrally formed with each other. A cable 800 is connected to the second contact 400B. The cable 800 is connected to a rear end of the second contact 400B in the front-rear direction. As shown in FIG. 31, each of the second contacts 400B is held by the second housing 210B. Specifically, each of the second contacts 400B is directly held by the second housing 210B. More in detail, each of the second contacts 400B is press-fit into the second housing 210B. However, the present invention is not limited thereto. Specifically, the second contact 400B may be indirectly held by the second housing 210B. In other words, the second contact 400B should be directly or indirectly held by the second housing 210B. Referring to FIGS. 31 and 34, each of the second contacts 400B is movable together with the rotations of the axis portions 212. Each of the second contacts 400B is moved together with the rotation of the second housing 210B when the second housing 210B is rotated about the center 2122 of rotation. The second contacts 400B correspond to the first contacts 120, respectively.

As shown in FIG. 36, each of the second contacts 400B has a second contacting portion 410B.

As shown in FIG. 36, the second contacting portion 410B of the present embodiment has a flat-plate shape. As shown in FIG. 31, the second contacting portion 410B is located adjacent to a predetermined position PP in the second direction.

Although each of the first contacting portion 122 and the second contacting portion 410B has the flat-plate shape as described above, the present invention is not limited thereto. Specifically, the first contacting portion 122 may not have the flat-plate shape, and the second contacting portion 410B may not have the flat-plate shape. If the connector structure 10B is used in high-current applications similar to the present embodiment, it is desirable for each of the first contacting portion 122 and the second contacting portion 410B to have the flat-plate shape in order to increase a cross-sectional area of its current path.

As shown in FIG. 36, the second contacting portion 410B has a single protrusion 412B.

As shown in FIG. 36, the protrusion 412B of the present embodiment is circular. The protrusion 412B protrudes inward in the second direction. As shown in FIG. 34, the protrusion 412B is located on the center 2122 of rotation in the plane perpendicular to the second direction. A center of the circle of the protrusion 412B in the plane perpendicular to the second direction is located on the center 2122 of rotation.

Referring to FIG. 36, each of the pressing members 500B of the present embodiment is made of metal. As shown in FIG. 31, the pressing members 500B correspond to the first contacts 120, respectively. Each of the pressing members 500B is held by the second housing 210B. Accordingly, dissimilar to the pressing members 500 of the first embodiment, each of the pressing members 500B of the present embodiment is prevented from being moved relative to the second housing 210B in the plane perpendicular to the second direction.

Referring to FIGS. 31 and 34, each of the pressing members 500B is movable together with the rotations of the axis portions 212. Specifically, each of the pressing members 500B is moved together with the rotation of the second housing 210B when the second housing 210B is rotated about the center 2122 of rotation. At least in a state where the second contacting portion 410B is adjacent to the first contacting portion 122 in the second direction, a posture of the pressing member 500B is changeable between a first posture AT1 and a second posture AT2 by rotating the pressing member 500B about a predetermined axis 700B. Specifically, the predetermined axis 700B is the center 2122 of rotation of the axis portion 212. Additionally, the predetermined axis 700B extends in the second direction. When the second housing 210B is rotated from the first rotation position R1 to the second rotation position R2 in a state where the second contacting portion 410B is adjacent to the first contacting portion 122, the posture of the pressing member 500B is changed from the first posture AT1 to the second posture AT2. The pressing member 500B assumes the first posture AT1 when the second housing 210B is located at the first rotation position R1. The pressing member 500B assumes the second posture AT2 when the second housing 210B is located at the second rotation position R2. The protrusion 412B is located on the predetermined axis 700B in the plane perpendicular to the second direction. The center of the circle of the protrusion 412B in the plane perpendicular to the second direction is located on the predetermined axis 700B.

As shown in FIG. 36, each of the pressing members 500B has a spring portion 510 and two protruding portions 520. However, the present invention is not limited thereto. Specifically, the number of the protruding portion 520 may be one. Alternatively, the number of the protruding portions 520 may be three or more. In other words, the pressing member 500B should have the spring portion 510 and at least one protruding portion 520.

Referring to FIG. 36, the spring portion 510 of the present embodiment has a resilient property. As shown in FIG. 31, the spring portion 510 is located apart from the second contacting portion 410B in the second direction. The spring portion 510 is located apart from the protrusion 412B in the second direction. The predetermined position PP is located between the spring portion 510 and the second contacting portion 410B in the second direction. The predetermined position PP is located between the spring portion 510 and the protrusion 412B in the second direction. In the second connector 200B, a gap GPB exists between the second contacting portion 410B and the spring portion 510 in the second direction. Specifically, the second connector 200B has two of the gaps GPB. The gaps GPB correspond to the first contacts 120, respectively.

As shown in FIG. 35, each of the protruding portions 520 of the present embodiment has an arc-shaped cross-section in a plane perpendicular to the third direction when the posture of the pressing member 500B is the second posture AT2. As shown in FIG. 36, each of the protruding portions 520 of the present embodiment is supported by the spring portion 510 and is movable in the second direction by using the resilient property of the spring portion 510. As shown in FIG. 31, each of the protruding portions 520 protrudes toward the second contacting portion 410B in the second direction. Referring to FIGS. 31, 34 and 35, together with the change of the posture of the pressing member 500B, each of the protruding portions 520 is movable on a path, which is deviated from the predetermined axis 700B, in a plane defined by the first direction and the third direction.

Referring to FIGS. 28 and 31, when the second connector 200B is moved relative to the first connector 100B along the first direction in a state where the pressing member 500B assumes the first posture AT1 while a position of the groove 1222 matches a position of each of the protruding portions 520 in a plane defined by the second direction and the third direction, each of the protruding portions 520 is received in the groove 1222. More in detail, when the second connector 200B is moved relative to the first connector 100B along the first direction in the state where the pressing member 500B assumes the first posture AT1 while the position of the groove 1222 matches the position of each of the protruding portions 520 in the plane defined by the second direction and the third direction, each of the protruding portions 520 is, at least in part, received in the groove 1222. As shown in FIG. 31, when the second housing 210B is located at the first rotation position R1, each of the protruding portions 520 is located at a position which is deviated from the center 2122 of rotation of the second housing 210B in the plane perpendicular to the second direction. Specifically, when the posture of the pressing member 500B is the first posture AT1, each of the protruding portions 520 is located at the position which is deviated from the center 2122 of rotation of the second housing 210B in the plane perpendicular to the second direction. Each of the protruding portions 520 is located apart from the second contacting portion 410B of the second contact 400B in the second direction when the posture of the pressing member 500B is the first posture AT1. Each of the protruding portions 520 is located apart from the protrusion 412B in the second direction when the posture of the pressing member 500B is the first posture AT1. Each of the protruding portions 520 faces the groove 1222 of the first contact 120 in the second direction when the posture of the pressing member 500B is the first posture AT1. Each of the protruding portions 520 does not ride on any of pressed surfaces 1224 of the first contact 120 when the posture of the pressing member 500B is the first posture AT1.

As understood from FIGS. 34 and 35, when the second housing 210B is located at the second rotation position R2, each of the protruding portions 520 is located at a position which is deviated from the center 2122 of rotation of the second housing 210B in the plane perpendicular to the second direction. In other words, when the posture of the pressing member 500B is the second posture AT2, each of the protruding portions 520 is located at the position which is deviated from the center 2122 of rotation of the second housing 210B in the plane perpendicular to the second direction. As shown in FIG. 35, each of the protruding portions 520 is in contact with the first contacting portion 122 of the first contact 120 in the second direction when the posture of the pressing member 500B is the second posture AT2. The protruding portions 520 ride on the pressed surfaces 1224, respectively, of the first contact 120 when the posture of the pressing member 500B is the second posture AT2. The first contacting portion 122 is sandwiched between each of the protruding portions 520 and the second contacting portion 410B when the posture of the pressing member 500B is the second posture AT2. The first contacting portion 122 is sandwiched between each of the protruding portions 520 and the protrusion 412B when the posture of the pressing member 500B is the second posture AT2. The first contacting portion 122 is sandwiched between each of the protruding portions 520 and the second contacting portion 410B when the first connector 100B and the second connector 200B are mated with each other. The first contacting portion 122 is sandwiched between each of the protruding portions 520 and the protrusion 412B when the first connector 100B and the second connector 200B are mated with each other.

As shown in FIG. 36, the two protruding portions 520 include a first protruding portion 521 and a second protruding portion 522. As shown in FIG. 31, the first protruding portion 521 and the second protruding portion 522 are arranged in the first direction when the posture of the pressing member 500B is the first posture AT1. The first protruding portion 521 is located below the second protruding portion 522 in the up-down direction when the posture of the pressing member 500B is the first posture AT1. As shown in FIG. 36, the first protruding portion 521 and the second protruding portion 522 are arranged in the third direction when the posture of the pressing member 500B is the second posture AT2. The first protruding portion 521 is located forward of the second protruding portion 522 in the front-rear direction when the posture of the pressing member 500B is the second posture AT2.

As shown in FIG. 36, each of the pressing members 500B has a coupling portion 530.

As shown in FIG. 36, the coupling portion 530 of the present embodiment protrudes toward the second contacting portion 410B in the second direction. The coupling portion 530 is located between the two protruding portions 520. The coupling portion 530 couples the two protruding portions 520 with each other. As shown in FIG. 31, the coupling portion 530 and the two protruding portions 520 are linearly arranged in the first direction when the posture of the pressing member 500B is the first posture AT1. This facilitates formation of the protruding portions 520 and the coupling portion 530 of the pressing member 500B of the present embodiment. It is noted that a size of the coupling portion 530 in the third direction is the same as a size of any of the protruding portions 520 in the third direction when the posture of the pressing member 500B is the first posture AT1.

Referring to FIGS. 28 and 31, the coupling portion 530 is received in the groove 1222 when the second connector 200B is moved relative to the first connector 100B along the first direction in the state where the pressing member 500B assumes the first posture AT1 while the position of the groove 1222 matches the position of each of the protruding portions 520 in the plane defined by the second direction and the third direction. More in detail, the coupling portion 530 is, at least in part, received in the groove 1222 when the second connector 200B is moved relative to the first connector 100B along the first direction in the state where the pressing member 500B assumes the first posture AT1 while the position of the groove 1222 matches the position of each of the protruding portions 520 in the plane defined by the second direction and the third direction. As shown in FIG. 31, the coupling portion 530 faces the groove 1222 in the second direction when the posture of the pressing member 500B is the first posture AT1. The coupling portion 530 does not ride on any of the pressed surfaces 1224 when the posture of the pressing member 500B is the first posture AT1. As shown in FIG. 34, the coupling portion 530 has an arc-shaped cross-section in the plane perpendicular to the third direction when the posture of the pressing member 500B is the second posture AT2. The coupling portion 530 faces the groove 1222 of the first contact 120 in the second direction when the posture of the pressing member 500B is the second posture AT2. The coupling portion 530 does not ride on any of the pressed surfaces 1224 of the first contact 120 when the posture of the pressing member 500B is the second posture AT2. As shown in FIG. 36, the coupling portion 530 and the two protruding portions 520 are linearly arranged in the third direction when the posture of the pressing member 500B is the second posture AT2.

As shown in FIGS. 31 and 34, in the state where the second contacting portion 410B is adjacent to the first contacting portion 122, the coupling portion 530 is located on the predetermined axis 700B in the plane defined by the first direction and the third direction. In the state where the second contacting portion 410B is adjacent to the first contacting portion 122, the groove 1222 is located on the predetermined axis 700B in the plane defined by the first direction and the third direction.

As shown in FIG. 36, each of the pressing members 500B has a connection portion 550B.

As shown in FIG. 36, the connection portion 550B of the present embodiment connects the spring portion 510 and the second contacting portion 410B with each other. The connection portion 550B is bent from the spring portion 510 so that it extends outward in the second direction, and is bent so that it extends to the second contacting portion 410B. More in detail, when the posture of the pressing member 500B is the second posture AT2, the connection portion 550B is bent from the spring portion 510 so that it extends outward in the second direction, and is bent so that it extends downward in the up-down direction to reach the second contacting portion 410B.

As shown in FIG. 36, the second connector 200B has a mating portion 206B.

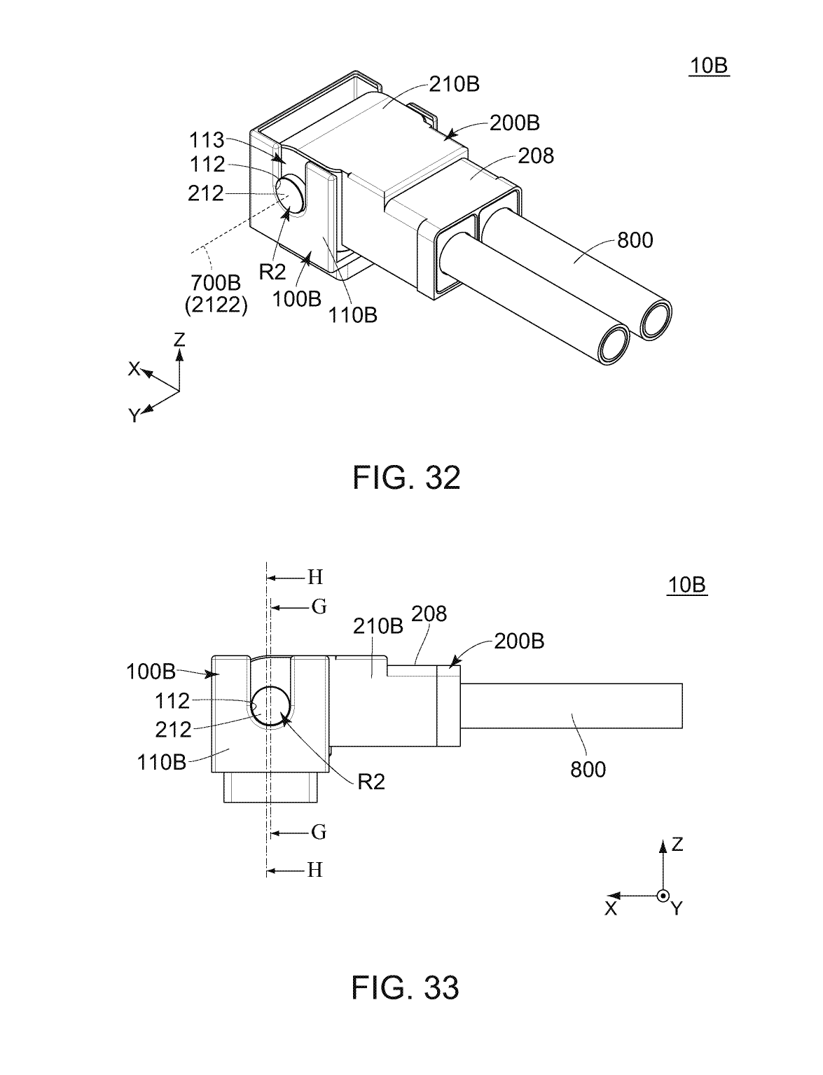

Referring to FIGS. 28 and 29, the mating portion 206B is accommodated in the mating portion accommodating portion 116B when the first connector 100B and the second connector 200B are mated with each other. As shown in FIG. 29, the mating portion 206B defines an end of the second connector 200B in the first direction when the second housing 210B is located at the first rotation position R1. Specifically, the mating portion 206B defines a lower end of the second connector 200B in the up-down direction when the second housing 210B is located at the first rotation position R1. As shown in FIG. 32, the mating portion 206B defines an end of the second connector 200B in the third direction when the second housing 210B is located at the second rotation position R2. Specifically, the mating portion 206B defines a front end of the second connector 200B in the front-rear direction when the second housing 210B is located at the second rotation position R2.

As shown in FIG. 36, the second connector 200B has an operation portion 208.

Referring to FIGS. 30 and 32, the operation portion 208 of the present embodiment is used for operating the rotation of the second housing 210B. The operation portion 208 is located apart from the center 2122 of rotation.

Hereinafter, a detailed description will be made about an operation of mating the first connector 100B with the second connector 200B.

First, referring to FIG. 28, the second connector 200B, in which the posture of each of the pressing members 500B is the first posture AT1, is located above the first connector 100B in the up-down direction while the position of the groove 1222 matches the position of each of the protruding portions 520 in the plane defined by the second direction and the third direction. This state is referred to as a pre-mated state.

From the pre-mated state, the second connector 200B is moved relative to the first connector 100B along the first direction. Specifically, the second connector 200B is moved downward in the up-down direction relative to the first connector 100B. Then, the mating portion accommodating portion 116B of the first connector 100B partially accommodates the mating portion 206B of the second connector 200B while the channel 113 of the first housing 110B partially accommodates the axis portion 212 of the second housing 210B. At this time, the regulating portion 114B regulates the movements of the regulated portions 214B in the second direction.

After that, the second connector 200B is further moved relative to the first connector 100B along the first direction. Specifically, the second connector 200B is further moved downward in the up-down direction relative to the first connector 100B. Then, while the regulating portion 114B regulates the movements of the regulated portions 214B in the second direction, the axis portion 212 is moved downward in the channel 113 and the first contacting portion 122 is inserted between the second contacting portion 410B and the spring portion 510. More in detail, while the regulating portion 114B regulates the movements of the regulated portions 214B in the second direction, the axis portions 212 are moved downward in the channels 113, respectively, and the first contacting portion 122 of each of the first contacts 120 of the first connector 100B is inserted into the corresponding gap GPB of the second connector 200B.

After that, the second connector 200B is yet further moved relative to the first connector 100B along the first direction. Specifically, the second connector 200B is yet further moved downward in the up-down direction relative to the first connector 100B. Then, while the regulating portion 114B regulates the movements of the regulated portions 214B in the second direction, the axis portion 212 is received in the bearing 112, and each of the protruding portions 520 is received in the groove 1222 and is moved in the groove 1222, and the second contacting portion 410B becomes adjacent to the first contacting portion 122. More in detail, while the regulating portion 114B regulates the movements of the regulated portions 214B in the second direction, the axis portions 212 are received in the bearings 112, respectively, and the two protruding portions 520 and the coupling portion 530 of the pressing member 500B of the second connector 200B are received in the groove 1222 of the corresponding first contact 120 of the first connector 100B and are moved downward in the groove 1222, and the second contacting portion 410B becomes adjacent to the first contacting portion 122. Accordingly, the connector structure 10B changes its state from the pre-mated state to a ZIF insertion state shown in each of FIGS. 29 to 31.

Summarizing the above, when the second connector 200B is moved relative to the first connector 100B along the first direction in a state where the pressing member 500B assumes the first posture AT1 while the position of the groove 1222 matches the position of the protruding portion 520 in the plane defined by the second direction and the third direction, the first contacting portion 122 is inserted between the second contacting portion 410B and the spring portion 510 while the protruding portion 520 is received in the groove 1222, and the second contacting portion 410B becomes adjacent to the first contacting portion 122. Accordingly, in the connector structure 10B of the present embodiment, the second contact 400B of the second connector 200B can be inserted into the first connector 100B with zero insertion force when the second connector 200B approaches the first connector 100B in a state where the posture of the pressing member 500B is the first posture AT1.

In the connector structure 10B taking the ZIF insertion state, the second housing 210B is rotated from the first rotation position R1 to the second rotation position R2 by tilting the operation portion 208 rearward. Then, the posture of the pressing member 500B is changed from the first posture AT1 to the second posture AT2. At this time, the first protruding portion 521 of the protruding portions 520 is moved forward and out of the groove 1222 so that the first protruding portion 521 rides on a first pressed surface 1225 of the pressed surfaces 1224. Also, at this time, the second protruding portion 522 of the protruding portions 520 is moved rearward and out of the groove 1222 so that the second protruding portion 522 rides on a second pressed surface 1226 of the pressed surfaces 1224. Accordingly, the connector structure 10B changes its state from the ZIF insertion state to a mated state shown in each of FIGS. 32 to 35. In the mated state, the protruding portions 520 press the pressed surfaces 1224, respectively, by using the resilient property of the spring portion 510 and thereby press the first contacting portion 122 against the second contacting portion 410B. More in detail, in the mated state, the first protruding portion 521 presses the first pressed surface 1225 by using the resilient property of the spring portion 510 while the second protruding portion 522 presses the second pressed surface 1226 by using the resilient property of the spring portion 510. This causes the first protruding portion 521 and the second protruding portion 522 to press the first contacting portion 122 against the protrusion 412B of the second contacting portion 410B in the mated state. It is noted that, in the mated state, the coupling portion 530 does not ride on any of the pressed surfaces 1224 and is located inward of the groove 1222 in the second direction.

Summarizing the above, when the posture of the pressing member 500B is changed from the first posture AT1 to the second posture AT2 in the state where the second contacting portion 410B is adjacent to the first contacting portion 122 while the protruding portion 520 is located in the groove 1222, the protruding portion 520 is moved out of the groove 1222 to ride on the pressed surface 1224, and the protruding portion 520 presses the pressed surface 1224 by using the resilient property of the spring portion 510 and thereby presses the first contacting portion 122 against the second contacting portion 410B. Accordingly, the connector structure 10B of the present embodiment is configured as follows: when the posture of the pressing member 500B is changed from the first posture AT1 to the second posture AT2 after the second contact 400B of the second connector 200B is inserted into the first connector 100B with zero insertion force, the protruding portion 520 of the pressing member 500B presses the pressed surface 1224 of the first contact 120, and thereby the first contacting portion 122 of the first contact 120 and the second contacting portion 410B of the second contact 400B are connected to each other. Thus, the connector structure 10B of the present embodiment can reduce operating force upon the mating of the first connector 100B and the second connector 200B without increasing a size of the connector structure 10B.

As described above, in the state where the second contacting portion 410B is adjacent to the first contacting portion 122, the coupling portion 530 is located on the predetermined axis 700B in the plane defined by the first direction and the third direction. Accordingly, the connector structure 10B of the present embodiment further reduces the operating force upon the mating of the first connector 100B and the second connector 200B.

Although the connector structure 10B of the present embodiment is configured so that the second housing 210B is rotatable by 90°, the present invention is not limited thereto. Specifically, the rotatable range of the second housing 210B may be less than 90°, provided that the connector structure 10B has a configuration as follows: when the second connector 200B is moved relative to the first connector 100B along the first direction in the state where the pressing member 500B assumes the first posture AT1 while the position of the groove 1222 matches the position of the protruding portion 520 in the plane defined by the second direction and the third direction, the first contacting portion 122 is inserted between the second contacting portion 410B and the spring portion 510 while the protruding portion 520 is received in the groove 1222, and the second contacting portion 410B becomes adjacent to the first contacting portion 122; and, when the posture of the pressing member 500B is changed from the first posture AT1 to the second posture AT2 in the state where the second contacting portion 410B is adjacent to the first contacting portion 122 while the protruding portion 520 is located in the groove 1222, the protruding portion 520 is moved out of the groove 1222 to ride on the pressed surface 1224, and the protruding portion 520 presses the pressed surface 1224 by using the resilient property of the spring portion 510 and thereby presses the first contacting portion 122 against the second contacting portion 410B.

Although the connector structure 10B of the present embodiment is configured so that the first housing 110B is provided with the bearings 112 while the second housing 210B is provided with the axis portions 212, the present invention is not limited thereto. Specifically, the connector structure 10B may be modified so that the first housing 110B is provided with an axis portion 212 while the second housing 210B is provided with a bearing 112. In other words, the connector structure 10B should be configured so that one of the first housing 110B and the second housing 210B is provided with the bearing 112 while a remaining one of the first housing 110B and the second housing 210B is provided with the axis portion 212.

Although each of the connector structures 10, 10B of the first and second embodiments is configured so that each of the pressing members 500, 500B has the two protruding portions 520 while the first contacting portion 122 of each of the first contacts 120 has the two pressed surfaces 1224, the present invention is not limited thereto. Specifically, the connector structure 10, 10B should be configured so that the pressing member 500, 500B has the single protruding portion 520 while the first contacting portion 122 of the first contact 120 has the single pressed surface 1224.

Although the specific explanation about the present invention is made above referring to the embodiment, the present invention is not limited thereto and is susceptible to various modifications and alternative forms.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector structure comprising a first connector and a second connector, wherein:
the first connector and the second connector are mateable with each other along a first direction;
the first connector comprises a first housing and a first contact;
the first contact is held by the first housing;
the first contact has a first contacting portion;
the first contacting portion is located at a predetermined position in a second direction perpendicular to the first direction;
the first contacting portion has a groove and a pressed surface;
the groove extends along the first direction;
the pressed surface is adjacent to the groove in a third direction perpendicular to both the first direction and the second direction;
the second connector comprises a second housing, a second contact and a pressing member;
each of the second contact and the pressing member is directly or indirectly held by the second housing;
the second contact has a second contacting portion;
the second contacting portion is located adjacent to the predetermined position in the second direction;
at least in a state where the second contacting portion is adjacent to the first contacting portion in the second direction, a posture of the pressing member is changeable between a first posture and a second posture by rotating the pressing member about a predetermined axis;
the pressing member has a spring portion and at least one protruding portion;
the spring portion has a resilient property;
the spring portion is located apart from the second contacting portion in the second direction;
the protruding portion is supported by the spring portion and is movable in the second direction by using the resilient property of the spring portion;
the protruding portion protrudes toward the second contacting portion in the second direction;
together with the change of the posture of the pressing member, the protruding portion is movable on a path in a plane defined by the first direction and the third direction, the path being deviated from the predetermined axis in the plane defined by the first direction and the third direction;
when the second connector is moved relative to the first connector along the first direction in a state where the pressing member assumes the first posture while a position of the groove matches a position of the protruding portion in a plane defined by the second direction and the third direction, the first contacting portion is inserted between the second contacting portion and the spring portion while the protruding portion is received in the groove, and the second contacting portion becomes adjacent to the first contacting portion; and
when the posture of the pressing member is changed from the first posture to the second posture in a state where the second contacting portion is adjacent to the first contacting portion while the protruding portion is located in the groove, the protruding portion is moved out of the groove to ride on the pressed surface, and the protruding portion presses the pressed surface by using the resilient property of the spring portion and thereby presses the first contacting portion against the second contacting portion.

2. The connector structure as recited in claim 1, wherein the first housing guides the second housing until the protruding portion is moved in the groove and the second contacting portion comes to be located adjacent to the first contacting portion while the first housing regulates a movement of the second housing in the plane defined by the second direction and the third direction.

3. The connector structure as recited in claim 1, wherein:
the second connector further comprises a shaft;
the shaft is held by the second housing so as to be rotatable between a first rotation position and a second rotation position;
the predetermined axis is a center of rotation of the shaft;
the pressing member is held by the shaft and is movable together with the rotation of the shaft; and
the posture of the pressing member is changed from the first posture to the second posture when the shaft is rotated from the first rotation position to the second rotation position in a state where the second contacting portion is adjacent to the first contacting portion.

4. The connector structure as recited in claim 3, wherein:
the connector structure further comprises a lever for operating the rotation of the shaft; and
the lever is attached to the shaft.

5. The connector structure as recited in claim 3, wherein:
the pressing member is made of metal;
the pressing member further has a receiving portion;
the receiving portion is located apart from the spring portion in the second direction; and
the second contacting portion is located between the spring portion and the receiving portion in the second direction.

6. The connector structure as recited in claim 1, wherein:
one of the first housing and the second housing is provided with a bearing;
a remaining one of the first housing and the second housing is provided with an axis portion;
the second housing is rotatable between a first rotation position and a second rotation position when the axis portion is supported by the bearing;
the predetermined axis is a center of rotation of the axis portion;
the pressing member is held by the second housing and is movable together with the rotation of the axis portion; and
the posture of the pressing member is changed from the first posture to the second posture when the second housing is rotated from the first rotation position to the second rotation position in a state where the second contacting portion is adjacent to the first contacting portion.

7. The connector structure as recited in claim 6, wherein the second contact and the pressing member are integrally formed with each other.

8. The connector structure as recited in claim 1, wherein the second contact is held by the second housing.

9. The connector structure as recited in claim 1, wherein:
the at least one protruding portion includes two of the protruding portions;
the pressing member has a coupling portion which couples the two protruding portions with each other;
the coupling portion protrudes toward the second contacting portion in the second direction;
the coupling portion and the two protruding portions are linearly arranged in the first direction when the posture of the pressing member is the first posture; and
the coupling portion is received in the groove when the second connector is moved relative to the first connector along the first direction in a state where the pressing member assumes the first posture while the position of the groove matches a position of each of the protruding portions in the plane defined by the second direction and the third direction.

10. The connector structure as recited in claim 9, wherein, in a state where the second contacting portion is adjacent to the first contacting portion, the coupling portion is located on the predetermined axis in the plane defined by the first direction and the third direction.

11. The connector structure as recited in claim 1, wherein the first contacting portion has a flat-plate shape.
